(19) United States
(12) Patent Application Publication
(10) Pub. No.: US 2014/0234809 A1
(43) Pub. Date: Aug. 21, 2014

(54) INTERACTIVE LEARNING SYSTEM

(71) Applicant: Matthew Colvard, Pacific Palisades, CA (US)

(72) Inventor: Matthew Colvard, Pacific Palisades, CA (US)

(21) Appl. No.: 13/832,267

(22) Filed: Mar. 15, 2013

Related U.S. Application Data
(63) Continuation of application No. 29/445,808, filed on Feb. 15, 2013.
Application No. 29/445,808 is a continuation of application No. 29/445,809, filed on Feb. 15, 2013.
Application No. 29/445,809 is a continuation of application No. 29/445,881, filed on Feb. 18, 2013.

(51) Int. Cl. G09B 17/00

(52) U.S. Cl. CPC G09B 17/006
USPC 434/169

(57) ABSTRACT

The present invention provides a system and method for interactively teaching phonics via an electronic device. The present invention enables a user to provide at least two forms of user input: oral and written, and the system recognizes these forms of input to provide feedback and load subsequent content based on user performance. An exemplary embodiment provides a sequence of lessons, each lesson teaching a new phoneme and reviewing previously-introduced phonemes through a series of activities. The activities can include: flipcard differentiation between a correct word including a phoneme and an incorrect word not containing the phoneme, trace and trace race for practicing writing a letter corresponding to a phoneme, Vocab for building vocabulary, story for reading a story comprised of learned words, and a review.

### CROSS-REFERENCE TO RELATED APPLICATIONS

This application claims priority to U.S. patent application Ser. No. 29/445,808 entitled ICON, filed Feb. 15, 2013; U.S. patent application Ser. No. 29/445,809, entitled USER INTERFACE, filed Feb. 15, 2013, and to U.S. patent application Ser. No. 29/445,881, entitled USER INTERFACE, filed Feb. 18, 2013, each of which is herein incorporated by reference in its entirety.

### FIELD OF THE INVENTION

The present invention relates to interactive learning systems, and more specifically to interactive learning systems for teaching phonics.

### BACKGROUND INFORMATION

Reading is a fundamental skill that beginning readers, such as children, typically develop by audible repetition of sounds and words accompanied by visualization of the object and spelling of the word over a period of weeks. English is particularly challenging, because although there are only about 40 “phonemes” (sounds) and 26 letters in the alphabet, there are over 400 different, logically inconsistent, and non-intuitive ways to spell those 40 sounds. Beginning readers are naturally curious, but may find learning to read frustrating, because of the inconsistencies in spelling, uninteresting reading material, or the lack of feedback on their progress.

“Phonics” refers to a method for teaching reading, writing, and spelling by associating phonemes with spelling patterns. Phonics enables beginning readers to decode new written words by “blending” the sound-spelling patterns (pronouncing the words). Educators have developed various patterns and rules describing sounds of letters and letter groups, such as vowels and consonants, in each language. However, these patterns and rules are complex and difficult for beginning readers to use in a purely written form.

Therefore, there is a need in the art to help beginning readers learn to read, write, and spell words in a methodical and engaging way that also provides feedback and helps beginning readers and their educators track their progress.

### SUMMARY OF THE INVENTION

The present invention provides a system and method for interactively teaching phonics. An exemplary embodiment provides a set of lessons that can be presented in electronic form, and that, when used regularly, can help learners become readers in four to six months. Each lesson teaches a new phoneme and reviews previously-introduced phonemes. Each lesson includes games and activities accompanied by animation and music. The design of the games and activities is targeted at hearing, writing, spelling, and associating new concepts with visualizations. Each lesson also includes a portion a story. The story can be a portion of a story that spans more than one lesson. The story can be tailored to the learner's age and particular needs, lend a sense of suspense and excitement to the task of learning, and help users to track progress. The lessons methodically teach phonics to beginning readers by activating auditory, visual, and kinetic learning. The lessons incorporate handwriting and speech recognition to provide beginning readers with feedback even when they are learning on their own. At the same time, the lessons can also improve learning in a classroom setting or under the tutelage of a human instructor.

The present invention provides a non-transitory computer-readable medium for storing instructions stored thereon for executing the steps of the various methods of the present invention.

The present invention provides a method for electronically teaching phonics including presenting phonemes, using a computer processor, in the following order: “p,” “u,” “o,” “t,” “n,” “a,” “d,” “i,” “g,” “b,” “m,” “e,” and “h.” The method further includes presenting at least the following words, using the computer processor, following the presentation of the phonemes “p” and “u”: up, pup; presenting at least the following word, using the computer processor, following the presentation of the phonemes “p,” “u,” and “o”: pop; presenting at least the following words, using the computer processor, following the presentation of the phonemes “p,” “u,” “o,” and “t”: pot, top; presenting at least the following words, using the computer processor, following the presentation of the phonemes “p,” “u,” “o,” “t,” and “n”: nut, on, not; presenting at least the following words, using the computer processor, following the presentation of the phonemes “p,” “u,” “o,” “t,” “n,” and “a”: ant, nap, tap, pat; presenting at least the following words, using the computer processor, following the presentation of the phonemes “p,” “u,” “o,” “t,” “n,” “a,” and “d”: dad, dot, pad, pond; presenting at least the following words, using the computer processor, following the presentation of the phonemes “p,” “u,” “o,” “t,” “n,” “a,” “d,” and “i”: pit, pin, nip, dip, tip; presenting at least the following words, using the computer processor, following the presentation of the phonemes “p,” “u,” “o,” “t,” “n,” “a,” “d,” “i,” and “g”: dog, tag, pig, dug, dig, tug; presenting at least the following words, using the computer processor, following the presentation of the phonemes “p,” “u,” “o,” “t,” “n,” “a,” “d,” “i,” “g,” and “b”: bug, bat, bag, tub, big, bad, bit; presenting at least the following words, using the computer processor, following the presentation of the phonemes “p,” “u,” “o,” “t,” “n,” “a,” “d,” “i,” “g,” “b,” and “m”: mop, mat, man, map, mad, mud, gum, damp; presenting at least the following words, using the computer processor, following the presentation of the phonemes “p,” “u,” “o,” “t,” “n,” “a,” “d,” “i,” “g,” “b,” “m,” and “e”: bed, ten, men, pen, net, pet, met, tent, mend, bend; and presenting at least the following words, using the computer processor, following the presentation of the phonemes “p,” “u,” “o,” “t,” “n,” “a,” “d,” “i,” “g,” “b,” “m,” “e,” and “h”: ham, hog, hen, hip, hut, hat, hit, hop, hid, hot, hug, hunt, hand, bop.

The present invention provides for a method for electronically teaching a phoneme, the method including: playing, using a computer processor, a sound of a phoneme; displaying, using the computer processor, a letter that represents the phoneme after playing the sound; displaying at least one word which contains the phoneme; displaying, using the computer processor, a GUI for selection of a correct picture whose name corresponds to the phoneme; displaying, using the computer processor, a letter that represents the phoneme, after displaying the GUI; and displaying, using the computer processor, a way of writing the letter without referring to the name of the letter. The method further includes playing, using the computer processor, a song using the phoneme.

The present invention provides for a method for electronically teaching a phoneme, the method including loading, using a computer processor, a word pair list for the phoneme; resetting, using the computer processor, a pair index; displaying images associated with the word pair for a current pair index; enabling a speech recognition engine to determine a user input; playing, using the computer processor, at least one of: a sound and a animation corresponding to the user input provided, wherein the user input is one of: unknown, incorrect, and correct; responsive to the user input being at least one of: correct and incorrect, incrementing the pair index using the computer processor; and responsive to a determination that the pair index is less than the total number of word pairs, returning to displaying images associated with the word pair for a current pair index. The method further may include: responsive to a determination that the current pair index is less than a predefined number, playing, using the computer processor, a sound corresponding to the images. The present invention provides for a method for electronically teaching a phoneme, the method comprising: displaying, using a computer processor, instructions for writing a letter corresponding to the phoneme; receiving a user input; determining, using the computer processor, that the user input corresponds to the letter; responsive to a determination that the user input corresponds to the letter, at least one of: displaying at least one of: an image and an animation, of the letter, playing an animation, and playing a sound. The method further may include that the image is anthropomorphic, having at least one eye. The method further may include adding the letter to a phoneme bar responsive to a determination that the user input corresponds to the letter.

The present invention provides a method for electronically teaching a phoneme, the method including: displaying, using a computer processor, instructions corresponding to a round index and resetting a current index; beginning a timer; clearing an input box at the current index; responsive to a determination by the computer processor that the user input is correct, incrementing the current index and at least one of: displaying an image of the letter, playing an animation, and playing a sound; responsive to a determination that the current index is more than a second predetermined number, determining whether the timer is still running; responsive to a determination that the timer is still running, incrementing the round index. The method further may include that the letter is anthropomorphic, having at least one eye. The method further may include: responsive to a determination that the round index is equal to a first predetermined number, displaying, using the computer processor, a trace letter at the input box and receiving a user input.

The present invention provides for a method for electronically teaching a phoneme, the method comprising: loading, using a computer processor, a word list for the phoneme; resetting, using the computer processor, a word index and a letter index; receiving a first user speech input and a user written input; responsive to a determination by the computer processor that at least the user written input is correct, incrementing the letter index; responsive to a determination that the letter index is greater than the word index, receiving a second user speech input; and responsive to a determination by the computer processor that the second user speech input is correct, displaying at least of: an image and an animation, for the word and incrementing the word index. The method further may provide that the letter index is incremented responsive to a determination both the user speech input and the user written input are correct.

The present invention provides for a method for electronically teaching a phoneme, the method comprising: loading, using a computer processor, a word list for the phoneme; resetting, using the computer processor, a word index and a timer; receiving a user input; responsive to a determination by the computer processor that the user input is correct, pausing the timer, incrementing the word index, and displaying at least one of: a sound and animation; and responsive to a determination by the computer processor that the timer completes before the word index reaches the number of word pairs in the word list, returning to loading a word list for the phoneme.

The present invention provides for a method for electronically teaching reading including: displaying, using a computer processor, a sentence corresponding to a sentence index; receiving a first user input corresponding to reading the sentence; responsive to a determination by the computer processor that the first user input is correct, at least one of: clearing the sentence from the display, playing an animation, reading the sentence to the user, and incrementing the sentence index; responsive to a determination by the computer processor that the first user input is incorrect, displaying a first word of the sentence; receiving a second user input for the first word of the sentence; and responsive to a determination by the computer processor that the second user input is incorrect, enabling touch to speech for the first word.

The present invention provides for a method for outputting a sound responsive to receiving a touch input including: receiving, via a touch-sensitive user terminal, a touch event having a touch point; responsive to a determination by a computer processor that the touch point is at least one of: inside a perimeter of a letter image and near the perimeter of the letter image, determining whether a start index is set; responsive to a determination by the computer processor that the start index is not set, setting a start index equal to a letter index and an end index equal to the letter index; responsive to a determination by the computer processor that the start index is set, determining whether the letter index is greater than the end index; responsive to a determination by the computer processor that the end index equals the letter index, waiting for a next touch event; and responsive to a determination by the computer processor that the next touch event occurs in greater than or equal to a predetermined time period, playing a sounds corresponding to a start to end index. The method further may provide that the letter image is at least one of: anthropomorphic and animated, anthropomorphic including having at least one eye.

### BRIEF DESCRIPTION OF THE DRAWINGS

FIG. 1 is a flowchart showing an example order of presentation of activities within a lesson.

FIG. 2A shows an example page for providing a graphical user interface (GUI) for beginning a lesson according to an embodiment of the present invention.

FIG. 2B shows an example page for providing a GUI for lesson management by a user according to an embodiment of the present invention.

FIG. 3A shows a first view of an example page for providing a GUI for a flip card activity according to an embodiment of the present invention.

FIG. 3B shows another view of an example page for providing a GUI for a flip card activity according to an embodiment of the present invention.

FIG. 4 is a flowchart illustrating an example method for providing a GUI via the flip card activity of FIGS. 3A and 3B according to an embodiment of the present invention.

FIG. 5A shows an example page for providing a GUI for a trace activity according to an embodiment of the present invention.

FIG. 5B shows an example letter for representing a symbol corresponding to a phoneme according to an embodiment of the present invention.

FIG. 6A shows a first view of an example page for providing a GUI for a trace race activity according to an embodiment of the present invention.

FIG. 6B shows another view of an example page for providing a GUI for a trace race activity according to an embodiment of the present invention.

FIG. 7 is a flowchart illustrating an example method for providing a GUI via the trace activity of FIG. 5A according to an embodiment of the present invention.

FIG. 8 is a flowchart illustrating an example method for providing a GUI via the trace race activity of FIGS. 6A and 6B according to an embodiment of the present invention.

FIG. 9A shows a first view of an example page for providing a GUI for a vocabulary activity according to an embodiment of the present invention.

FIG. 9B shows another view of an example page for providing a GUI for a vocabulary activity according to an embodiment of the present invention.

FIG. 10 is a flowchart illustrating an example method for providing a GUI via the vocabulary activity of FIGS. 9A and 9B according to an embodiment of the present invention.

FIG. 11 shows an example page for providing a GUI for a review activity according to an embodiment of the present invention.

FIG. 12 is a flowchart illustrating an example method for providing a GUI via the review activity of FIG. 11 according to an embodiment of the present invention.

FIG. 13 is a flowchart illustrating an example method for providing a GUI via a reading activity according to an embodiment of the present invention.

FIG. 14 is a flowchart illustrating an example method for updating content based on lesson progress according to an embodiment of the present invention.

FIG. 15 is a flowchart illustrating an example method for transferring touch gestures to speech according to an embodiment of the present invention.

FIG. 16 is a flowchart illustrating an example method for synchronizing a series of audio and image-based animation according to an embodiment of the present invention.

FIG. 17 is a flowchart illustrating an example method for displaying a phoneme bar in a GUI according to an embodiment of the present invention.

FIG. 18 is a flowchart illustrating an example method for providing a GUI via the trace race activity of FIGS. 6A and 6B according to an embodiment of the present invention.

### DETAILED DESCRIPTION

The present invention provides an interactive learning system for phonics that can be used on electronic devices such as mobile devices, computers, and tablets. In an embodiment, the interactive learning system can be implemented as a web application, for example, accessible via a web browser. In another embodiment, the interactive learning system can be implemented as a mobile application. Amusing age-appropriate animated characters can be used in stories and exercises that foster the ability to hear (discriminate), segment (identifying a discrete unit in a stream of speech), and blend phonemes in words. Some of the animated characters can be recurring throughout a lesson or can appear in multiple lessons. These animated characters can serve a narrator function, for example, by giving users instructions for each activity. In the present invention, one such recurring character is referred to as “cartoon dog” and “Professor Pup,” but this is merely meant to be exemplary and the narrator can be any animal or take on any other form. The stories and exercises also help students remember letters and/or letter patterns that stand for phonemes, write letter shapes, and read words, phrases, and sentences fluently and accurately. Each lesson can contain a set of activities presented in a predetermined order. The type of activity can be the same for each lesson, but the content can be adapted, for example, via method 1400 detailed below, as the student progresses in his or her reading skills.

In an embodiment, a single lesson can teach a single phoneme and review all previously introduced phonemes. The phonemes are introduced in the following order: p, u, o, t, n, a, d, i, g, b, m, e, h, r, j, v, z, l, f, s. In another embodiment, words are introduced after the phonemes in the following order:

p, u, up, pup,

o, pop,

t, pot, top,

n, nut, on, not,

a, ant, nap, tap, pat

d, dad, dot, pad, pond

i, pit, pin, nip, dip, tip,

g, dog, tag, pig, dug, dig, tug,

b, bug, bat, bag, tub, big, bad, bit

m, mop, mat, man, map, mad, mud, gum, damp,

e, bed, ten, men, pen, net, pet, met, tent, mend, bend

h, ham, hog, hen, hip, hut, hat, hit, hop, hid, hot, hug, hunt, hand, bop.

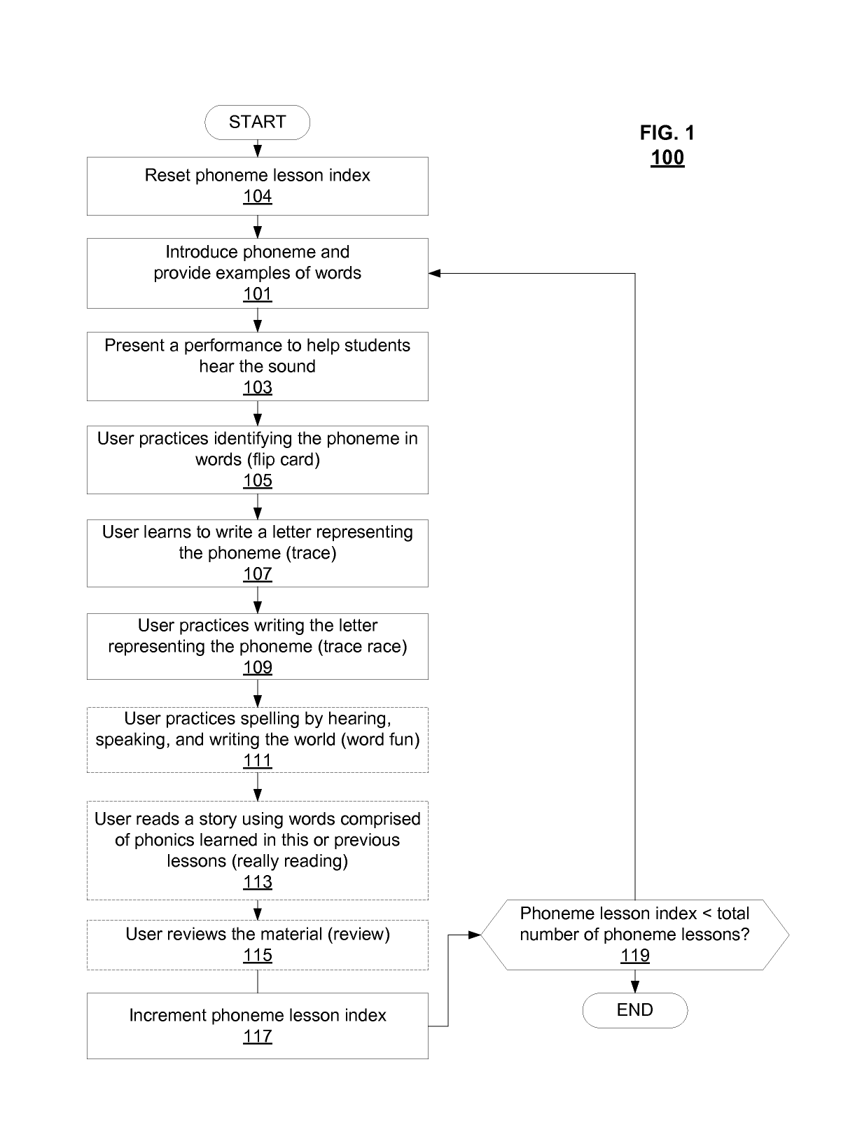

FIG. 1 illustrates an example method 100 by which activities are presented in a lesson. In a first step 104, the method 100 resets a phoneme lesson index. The phoneme lesson index tracks a user's progression through the lessons, such that a user can complete part or all of a lesson and return it to a later time. Each lesson in a set of lessons is associated with a unique phoneme lesson index. For example the first lesson can have a phoneme lesson index of 1, the second lessons can have a phoneme lesson index of 2, and the last lesson can have a phoneme lesson index corresponding to the total number of lessons. The lessons can be introduced in the order described above.

After resetting the phoneme lesson index in step 104, the method 100 proceeds to step 101 in which it can introduce the phoneme that will be mastered by the end of the lesson (also referred to as “target phoneme”) and provide a predefined number of examples of words that use the phoneme. In an embodiment, a visualization or image of the example word can be presented along with the example word.

In step 103, the method 100 can show a performance stressing words that use the target phoneme to help students hear the sound of the target phoneme. The performance can be a song (e.g., a rap), a dance, or any other performance that aids memorization and learning of new concepts. Both the steps 101 and 103 help the student to hear the sound of the target phoneme.

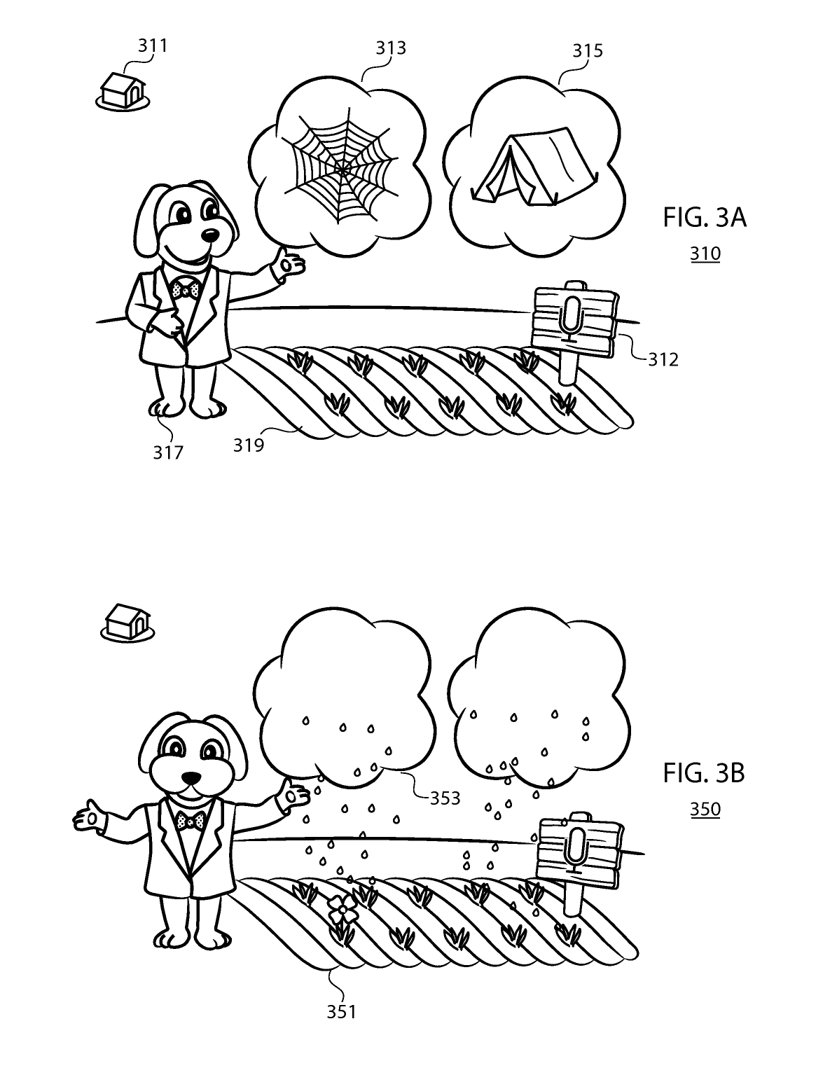

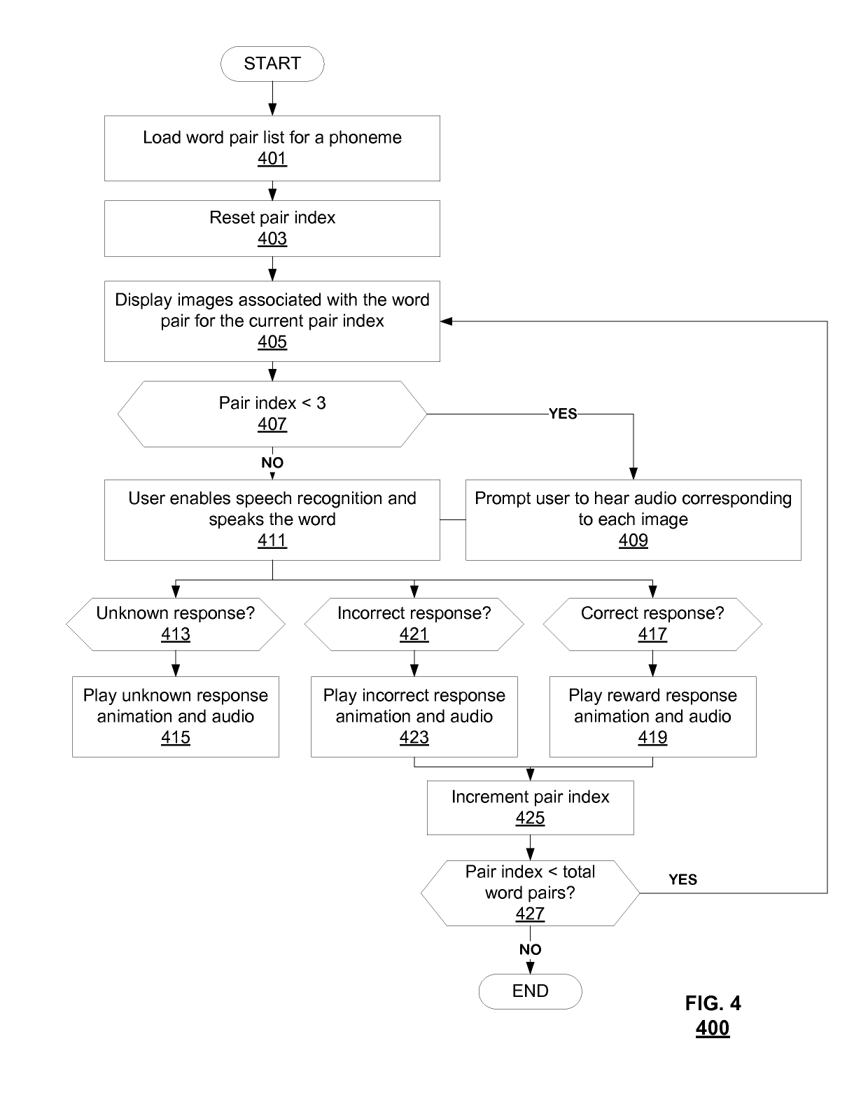

In step 105, the method 100 prompts the user to identify the phoneme associated with word(s) presented to the user. The activity in step 105 can correspond to a flip card activity further detailed in FIGS. 3A, 3B, and 4. For example, the method 100 presents images of two objects. The user can select the image that represents a word associated with the target phoneme. A predefined number of pairs of words can be presented. The method 100 can track a user's progress within the same GUI. For example, accurate selection of words containing the target phoneme can result in progress towards a goal that can be animated on-screen.

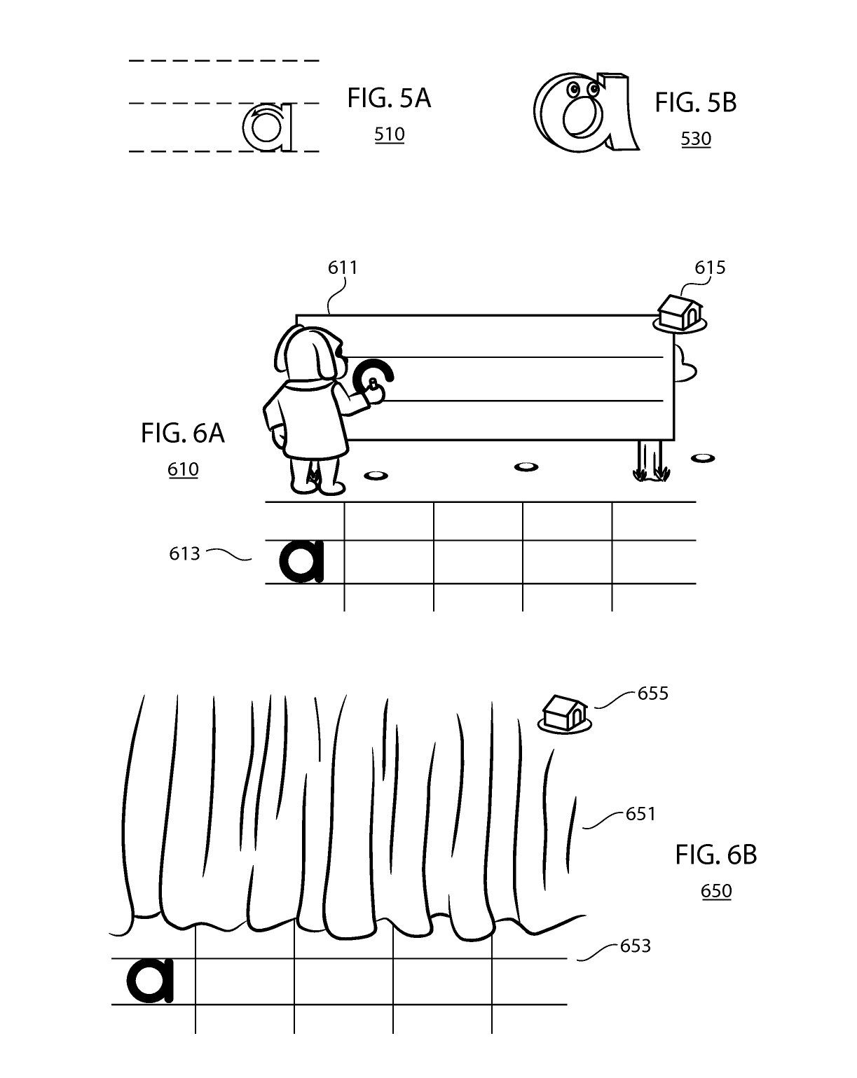

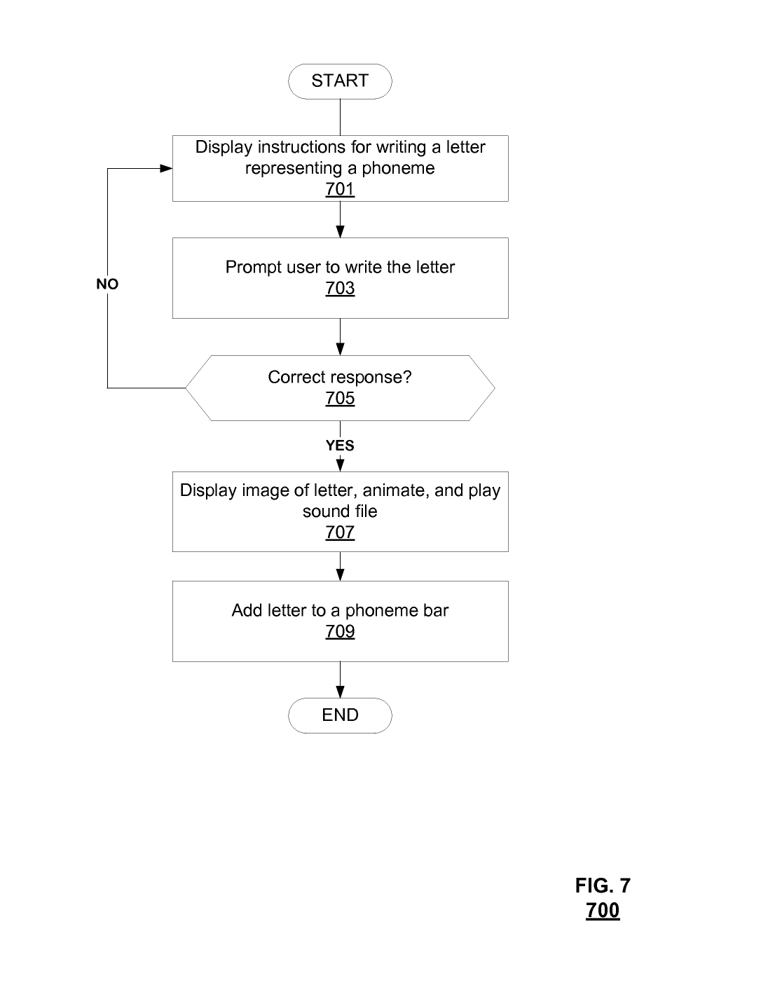

In step 107, the method 100 prompts a user to learn to write a letter representing the target phoneme. The activity in step 107 can correspond to a trace activity further detailed in FIGS. 5 and 7. The method 100 can demonstrate the correct formation of the letter. The user can then be prompted to trace the letter. For example, the user can use a mouse or, in the case of devices with touch-screen technology, a stylus or finger. The letter can be printed on-screen, directing the user to form each letter in the proper manner, which can be in terms of a sequence of motion and placement within lines. The number of times that a user is prompted to trace a letter can be predefined or adapted to the user's level of skill.

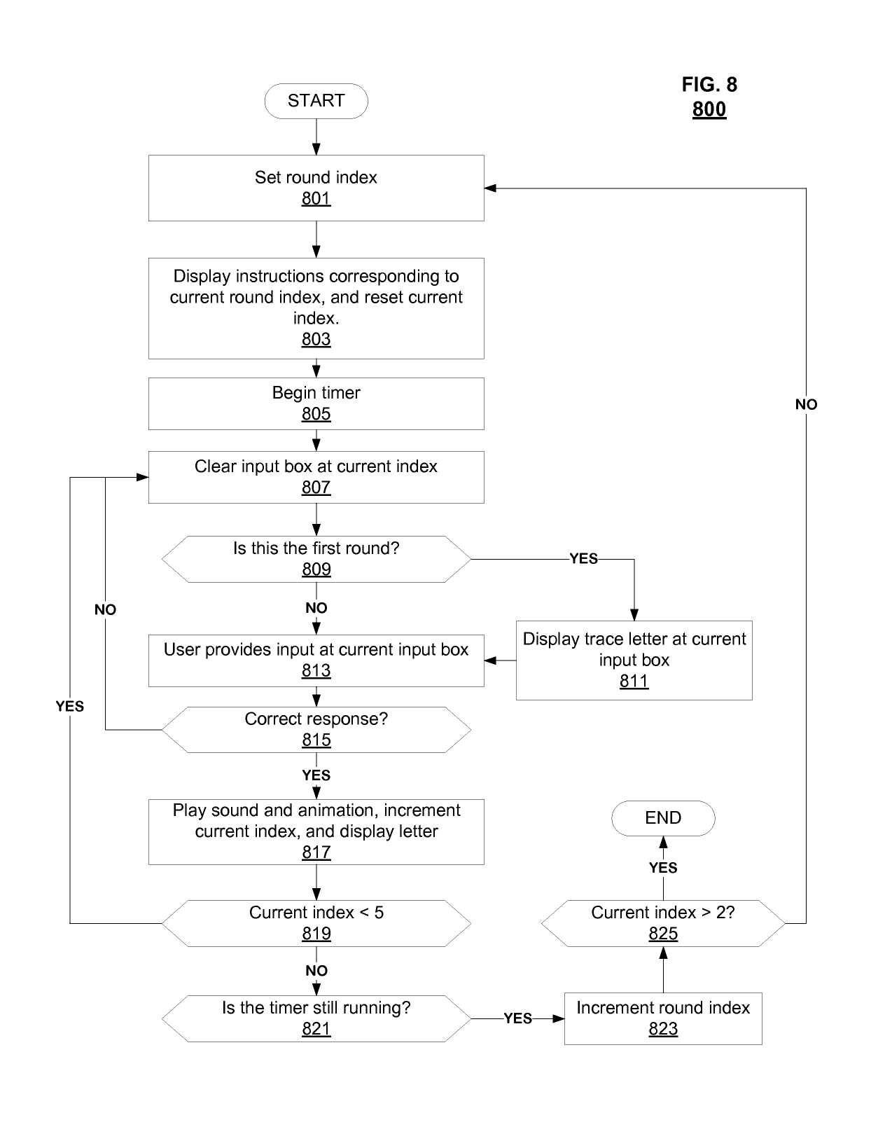

In step 109, the method 100 prompts a user to practice writing a letter representing the target phoneme. The activity in step 109 can correspond to a trace race activity further detailed in FIGS. 6A, 6B, and 8. This practice can cement letter awareness and the ability to form the new letter correctly and quickly. For example, this can be done in a game-like fashion, by prompting the user to race against the recurring animated character. The number of times that a user is prompted to trace a letter can be predefined or adapted to the user's level of skill.

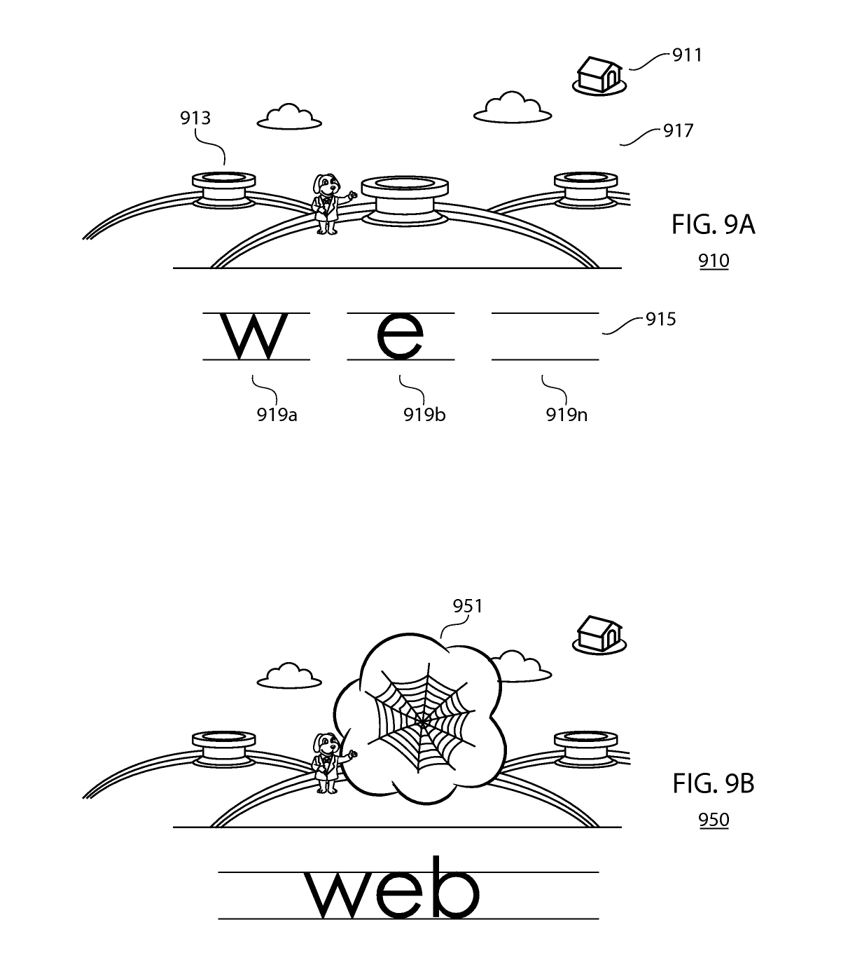

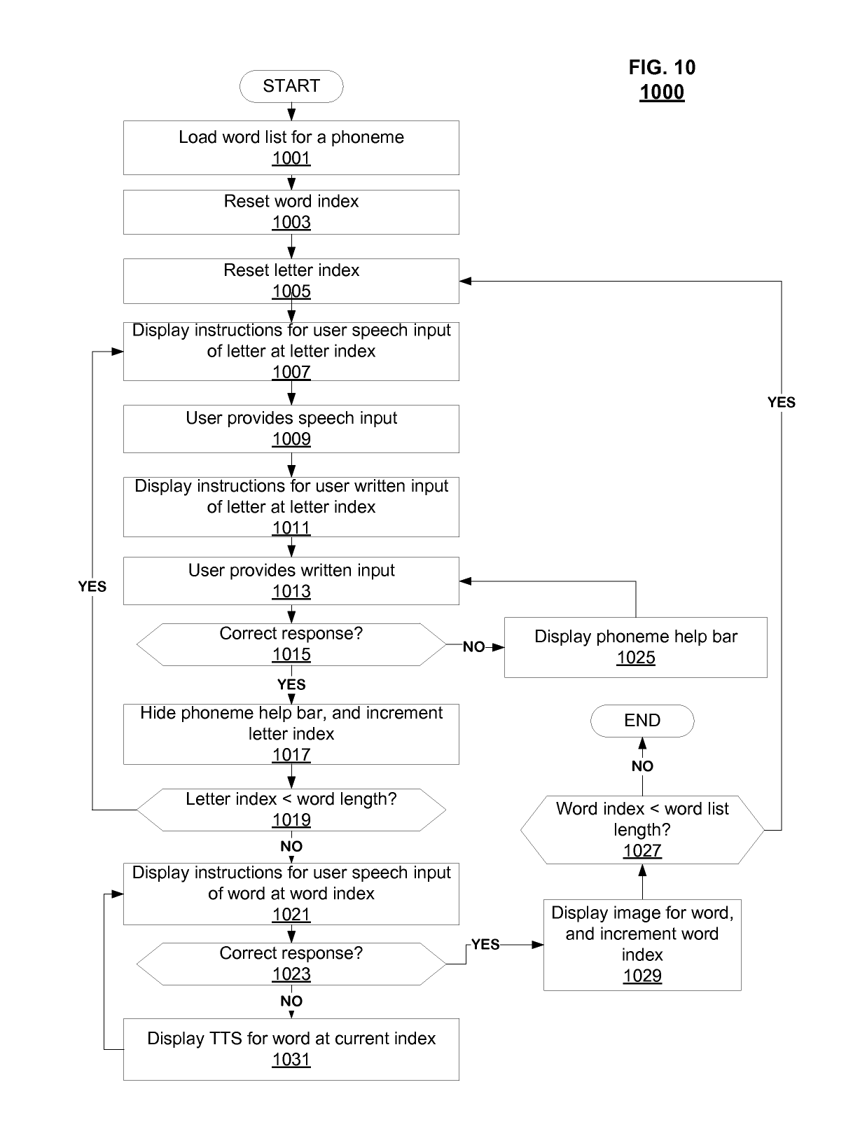

In step 111, the method 100 helps a user practice spelling by outputting the sound of phonemes making up a word, prompting the user to repeat the sound, writing the letter associated with each sound, and blending the sounds together to make words. The activity in step 111 can correspond to a vocabulary (“Vocab” for convenience) activity further detailed in FIGS. 9A, 9B, and 10. The user can hear blending of sounds and simultaneously or sequentially see the blending of letters to make words. If the electronic device has an audio input, the method 100 can verify the accuracy of the pronunciation when prompting the user to repeat the sound. The method 100 can provide feedback when a pronunciation is incorrect.

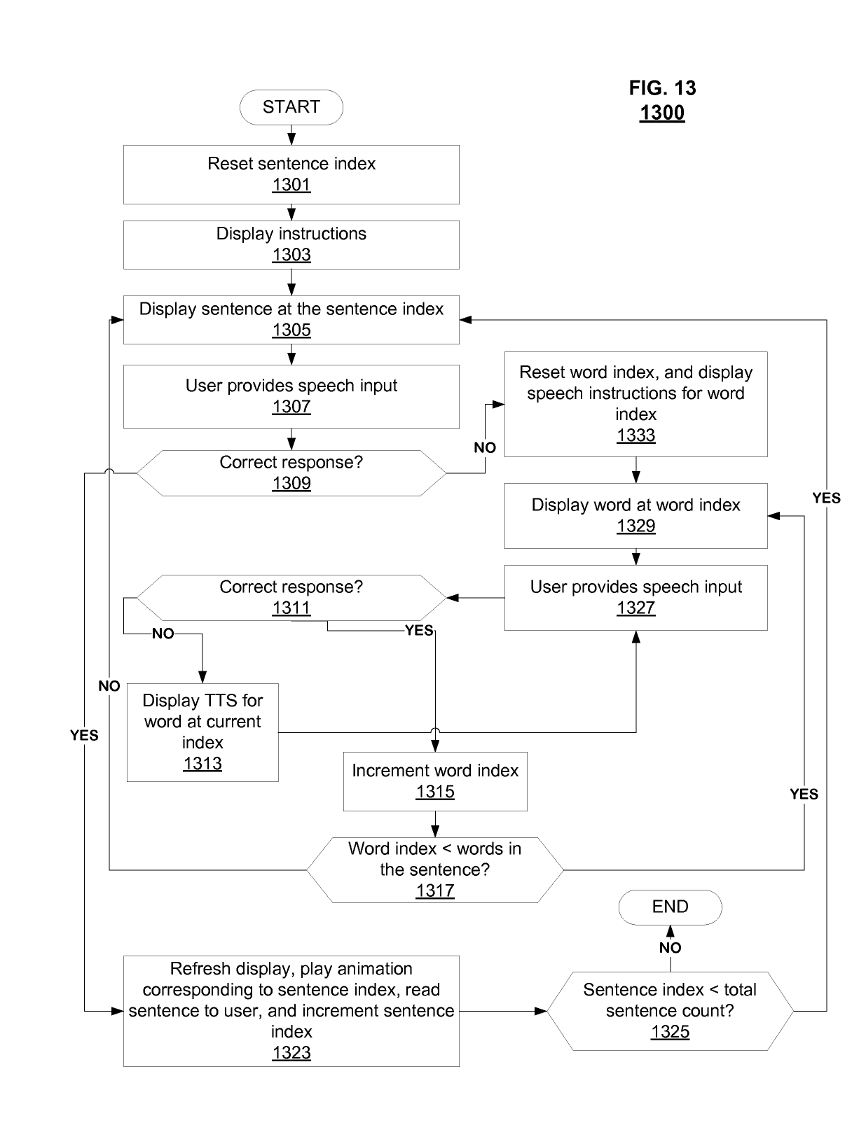

In step 113, the example method 100 displays a story for the user to read. The activity in step 113 can correspond to a story activity further detailed in FIG. 13. The story can use words comprised of phonics learned in the current lesson and/or previous lessons. The story can be accompanied by animations, music, and/or other interactive components.

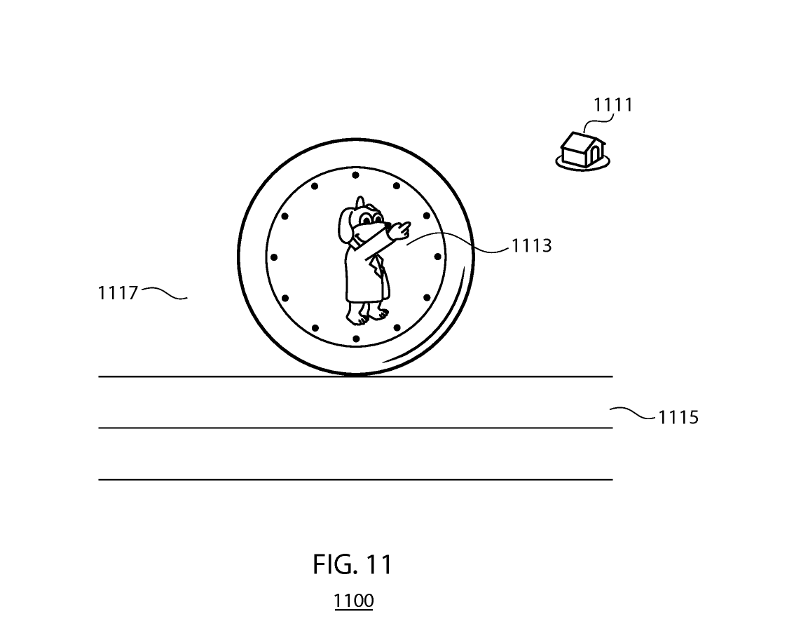

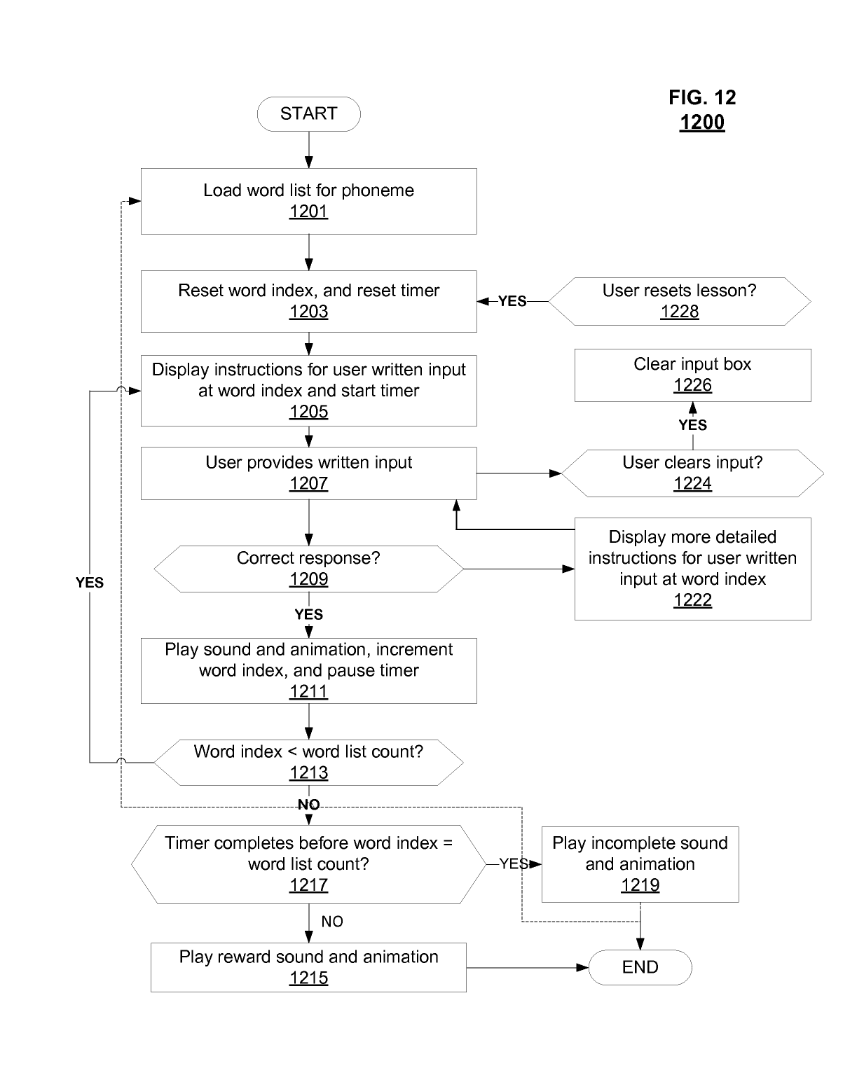

In step 115, the method 100 can help a student to review reading and writing the words learned in the lesson. The activity in step 115 can correspond to a review activity further detailed in FIGS. 11 and 12). The review can be timed. In step 117, the phoneme lesson index is incremented. In step 119, the method 100 then queries whether the phoneme lesson index is less than the total number of phoneme lessons. If the answer is yes, then the method begins at step 104. If the answer is no, and the phoneme lesson index is greater or equal to the number of phoneme lessons, then the method 100 is over.

In an embodiment, all lessons have each of the activities detailed above. In another embodiment, not all lessons have the activities detailed above, and can omit some combination of the activities corresponding to steps 103, 105 111, 113, and 115 (shown in dashed lines). In embodiments, the omission occurs for lessons in the later stages of the lesson set. This can be predetermined by the platform or the user via the teacher mode described below. In embodiments, when operating under teacher mode, the user can skip around and select which section to load, but cannot reconfigure and a store a new order of the section. The activities that can be incorporated into each lesson are discussed through example embodiments in further detail below. In an embodiment, for each lesson, the order of activities is the same. In another embodiment, for each lesson, the order of activities is different.

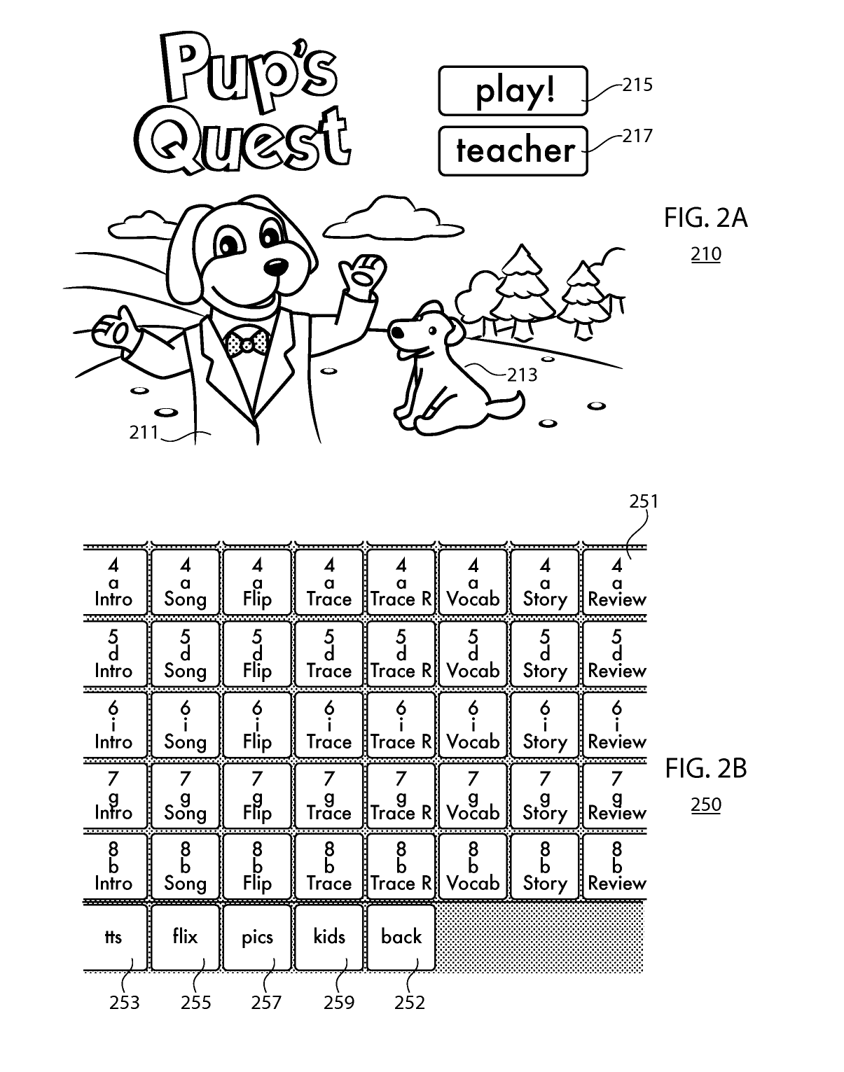

FIG. 2A shows an exemplary start page 210 for providing a graphical user interface (GUI). The page can include drawings 211 and 213, which can be recurring characters in the set of lessons. The drawings 211 and 213 can be animated. The page can also include buttons (also referred to as “links”) 215 and 217, which enable users to activate corresponding functions. A user can begin a lesson, in which the user learns a target phoneme by activating the “Play!” link 215. A link can be activated by clicking, hovering, or otherwise indicating selection of the link. If a user desires to continue with a lesson, content is loaded and the user continues with the next lesson in a sequence of lessons (for example, the lesson plan described above). Content can be loaded according to the method 1400 further described below. A user can also learn a target phoneme by activating the “Teacher” link 217.

FIG. 2B shows an example teacher page 250 for providing a GUI to enable lesson management. In an embodiment, the teacher page 2B loads upon activation of link 217. This GUI enables a user to bypass the sequence of lessons predefined by the platform and instead choose a particular lesson. For each lesson, the user can select a link to directly activate a display of a GUI associated with an activity for a particular lesson. For example, selection of button 251 loads the review activity of the lesson teaching the phoneme “a.” In embodiments, the following buttons have the following functionalities. Button 253 can activate a function to view a list of words which the user has already correctly input in a vocabulary exercise, for example in step 1023 of method 1000. In embodiments, the user can select words from this list to activate functions related to touch to speech and swiping (TTS), such as the one described in method 1500. Button 255 can activate a function to view a list of animations the user has already seen in a vocabulary exercise, such as steps 1029 1323 of method 1000. In embodiments, the user can select animations from this list to watch the animations again. Button 257 can activate a function to view a list images the user has already seen in a vocabulary exercise, for example in step 1029 of method 1000. In an alternative embodiment, Button 257 can activate a table of images the user has already seen in a vocabulary exercise, for example in step 1029. Button 259 can activate a function to bring up a list of multiple users who have created accounts on the device. In an alternative embodiment, Button 259 can activate a function to bring up a list of users in a group, e.g. all of the users who have created accounts across several devices, such as many users in a classroom who each have an account on a separate device. By selecting a user account name from this list, the user can call up data about the user's performance including metrics such as progress through the lessons, percentage of accurate responses, length of time spent on sections, etc. Button 252 can activate a function to return the user to a start page such as page 210 of FIG. 2A. In an embodiment, the teacher link 217 is password protected.

FIGS. 3A and 3B show two views of an example page for providing a graphical user interface (“GUI”) for a flip card activity. In an embodiment, the page includes a graphic 317, a graphic 319 for tracking progress, a link 312 for enabling speech recognition, graphic blocks 313 and 315 for displaying pictures and/or animations, and a link 311 to return to a home page. In an embodiment, the graphic 317 may be a recurring character, who appears in one or more lessons. In an embodiment, the graphic 317 is an animated “narrator” for providing instructions for the flip card activity.

In an embodiment, the graphic 319 for tracking progress is animated and/or dynamically changes with the progression or performance of the user input. For example, when a user answers a flip card question correctly, rain 353 falls and the graphic 319, in this case, a garden, grows a flower 351 to show progress towards a final goal (here, a garden complete with flowers). The garden can have a predefined number of spaces for flowers to grow, for example, 10 spaces. The predefined number of spaces can correspond to the total possible number of word pairs. The flower 351 can grow in any space. In an embodiment, each space corresponds to a pair index (further discussed below), and a flower 351 grows in the space corresponding to the current pair index if a correct response is given. In an alternative embodiment, a part of the screen displays a number starting with zero. Each correct answer increases that number by one. In an alternative embodiment, there are blank spaces in which icons such as “coins” can appear. Each correct answer results in an icon appearing.

In an embodiment, graphic blocks 313 and 315 each display an object. Touching graphic blocks 313 and/or 315 triggers a sound file containing the name of the object contained in the indicated graphic block to play. For example, if there is a picture of a “man” in the cloud, the user hears “man” when the sound file is played. In an embodiment, the name of one of the objects, for example in block 313, contains the target phoneme, while the other object, for example in block 315, does not. In an embodiment, the user is prompted by the platform to identify the name of the object that contains the target phoneme, for example by saying it out-loud. For example, the instructions are “Name which one starts with the sound [phoneme],” or “Name which one has the sound [phoneme].” In an embodiment, the user is prompted by the platform to identify the name of the object that contains the target phoneme for a predefined number of times. Each time, whether the object whose name contains the phoneme is displayed in the graphic block 313 or the graphic block 315 is determined randomly.

In an embodiment, the link 312 is a graphic, such as a placard with a microphone as shown. When the user selects the link 312, for example by tapping a touchscreen area corresponding to the link, a microphone in the user terminal is activated to capture the user's answer to the question presented and a speech recognition engine in the platform is activated for processing the speech data captured by the microphone and transmitted to the speech recognition engine.

In an alternative embodiment, there is no microphone icon 312 or speech recognition. Instead, the user is asked to touch the picture of the object that starts with the correct phoneme. If the phoneme is a vowel, the user is asked to touch the picture of the object that contains the correct phoneme. Correct answers cause icons to appear and the user to advance to the next round. In an alternative embodiment, there is an arrow icon on the screen (not shown). Touching the arrow icon causes the program to register a correct answer and advances the user to the next round.

In an alternative embodiment, the user can be quizzed on the correct phoneme with more than two boxes. For example, four boxes are displayed on the GUI. For example, only one of the four boxes contains a picture of an object whose name contains the correct phoneme (referred to as “correct box”). The user must select the correct box but not select the three boxes with the pictures of an object whose name does not contain the correct phoneme. In another example, more than one of these boxes contain pictures of objects whose names contain the correct phoneme. The user selects (for example, by touching) the correct boxes, but not select the boxe(s) containing the picture of an object whose name does not contain the correct phoneme.

FIG. 4 is a flowchart illustrating a method 400 for providing a GUI via the flip card activity of FIGS. 3A and 3B. The method begins at step 401 by loading a list of word pairs for the target phoneme and resetting a pair index in step 403. A word pair consists of a correct word that contains the target phoneme and an incorrect word that does not contain the target phoneme. In an embodiment, the word pair also includes an object (for example, an image or animation) representing the word, for each word in the word pair. A pair index is a counter for tracking how many word pairs a user has viewed in the current session. In step 405, the method 400 displays the image associated with each word in the word pair in a graphical block of the GUI. Each image is displayed in a separate area within the graphical block. The method 400 determines whether the flip card activity is in its early stages in step 407. For example, the pair index may be less than a predetermined number (here, “three”), indicating that the user has viewed less than three pairs of images in the current session. If the flip card activity is in its early stages, the method 400 proceeds to step 409 in which the user is prompted to hear how a word is pronounced for the corresponding word image. In an embodiment, the user indicates a desire to hear the word audio by tapping an area corresponding to the word image in the graphical block of the GUI. After hearing the word audio, the user enables speech recognition (for example, by tapping a microphone as described above) and speaks the word in step 411.

The method 400 queries whether the user's speech input is unknown (box 413), correct (box 417), or incorrect (box 421). The speech recognition engine can translate the user's speech input into corresponding written text. If the written text matches the incorrect word (for example, the incorrect word representing the other image presented), the response is incorrect. If the written text matches the correct word, the response is correct. Otherwise, if the speech recognition engine is not able to recognize the speech input, the response is an unknown response. For example, the speech recognition engine is not able to recognize the speech input if there was a technical error or the written text does not correspond to either the correct word or the incorrect word. Based on the type of response the user gave in steps 413, 417, and 421, the method 400 plays a corresponding animation and audio (boxes 415, 419, and 423). For example, the audio file corresponding to an incorrect response (423) contains the words “I don't hear a [target phoneme] in [name of incorrect object]. For example, the audio file corresponding to an unknown response (box 415) contains the words “Hmm, could you try that again?”

In an embodiment, the reward animation and audio file in step 419 further includes tracking the user's progress. For example, an icon appears in the tracking progress area of the screen. For example, this icon is a picture of a flower. At the same time, the narrator (for example, a cartoon dog) does a backflip, and a sound file plays. For example, the audio file corresponding to a correct response (box 419) is phrase which expresses affirmation such as “awesome” or “good job.”

If the response given by the user is correct or incorrect, the pair index is incremented to indicate completion of the identification of the current word pair in step 425. The method 400 then checks whether there are any word pairs that have not been previously presented in step 427. For example, the pair index is less than the total number of all possible word pairs. If there are word pairs that have not been previously presented, the user advances to the next round. That is, the method 400 returns to step 405 and displays another word pair. The number of rounds per game can be predefined, for example 8-10 rounds per game. If all possible word pairs have been presented, then the method 400 ends. In an embodiment, the user can be advanced to the next section “Trace” as further described below.

FIG. 5A shows an example page 510 for providing a GUI for a trace activity. A symbol corresponding to the target phoneme of the lesson may be displayed on the page. In an embodiment, the symbol is a picture of one or more letters (corresponding to a phoneme) of the alphabet in the center of the screen. An animated graphic may show the way the symbol is written including the directions of strokes, as represented by the arrow. In an embodiment, an image can be displayed if a user correctly traces a letter. The image can be an “anthropomorphic” letter (for example, a brightly-colored alphabetic character with eyes that can blink as shown in FIG. 5B). In an alternative embodiment, the “anthropomorphic” letter has a mouth (not shown) in addition to blinking eyes. The anthropomorphic letter can make recurring appearances throughout the lesson.

FIG. 7 is a flowchart illustrating a method 700 for providing a GUI via the trace activity of FIG. 5. The method 700 begins in step 701 by displaying instructions for writing a letter representing the target phoneme. In an embodiment, the instructions are in the form of a sound file and an animation showing the correct way (including stroke order) to form the letter. For example, the sound file contains the phrase, “This is how you write the sound . . . ” followed by a sound file containing the phoneme that is associated with that letter. For example, in the animation, a line darker in color and thinner than the letter traces the outline of the letter demonstrating how the letter is written. In an embodiment, the line has an arrow at its front such that it gives a visual cue of the direction the line is headed. The animation is followed by a sound file containing the phrase “Now it's your turn.”

The method then proceeds to step 703 in which the user is prompted to draw the letter (for example via a touch screen of a user terminal), and a handwriting recognition engine of the platform determines whether the letter has been written correctly in step 705. If the user wrote the letter correctly in step 705, an image of the letter is displayed on the GUI and a sound corresponding to the target phoneme plays in step 707. In an embodiment, the anthropomorphic letter 530 is animatedly-displayed. For example, the image appears in the middle of the GUI surrounded by shooting stars and a sound file containing the phoneme associated with that letter plays. The method then proceeds to step 709 in which the image of the phoneme is accompanied by further animation, which places the image in a repository of previously learned phonemes. For example, the “anthropomorphic” letter moves in a parabolic trajectory towards the upper right hand of the screen. If the user has completed previous “Trace” sections, then all of the “anthropomorphic” letters from prior sections, for example other lessons and target phonemes, appear at the top of the screen. The method 700 then ends. In an embodiment, the user can be advanced to the next section “Trace Race” as further described below.

If the user did not write the letter correctly in step 705, a sound file indicating the user's response was incorrect plays. For example, the sound file contains the phase “Not quite.” The method 700 then returns to step 701. In an alternate embodiment, a user can write a letter multiple times, for continued feedback. In an embodiment, the system can be preset to allow for a specific amount of attempts by a user.

FIGS. 6A and 6B show example pages 610 and 650 for providing a GUI for a trace race activity. FIG. 6B shows an example page 650 before a timer begins in the trace race activity. In an embodiment, an animation such as a video is displayed on the GUI (an example embodiment is shown in FIG. 6A). For example, the video having dimensions 1024 pixels by 461 pixels is displayed at the top of the screen. The video is at least partially obscured, for example, by an image of a stage curtain 651, as shown, or by another graphic before a timer signals the beginning of the trace race. In an embodiment, there is at least one text input box 653 in which the user can provide input, displayed on the GUI. For example, five text boxes having a height of 307 pixels are displayed at the bottom of the screen. The first box includes a picture of the letter (referred to as “example letter”) representing the letter the user is instructed to draw in the trace race activity. In an embodiment, the instructions can be provided via a sound file. For example, the sound file includes the instruction, “Write the sound in the first box, to get to the next box. Can you do it faster than me? You can try. Ready, set,” followed by a sound file of the lesson's target phoneme. In an embodiment, as in all other GUIs presently described, at any time, the user can select the home link (for example, shown as a house or doghouse 615 in the upper right corner in FIG. 6A, and as house or doghouse 655 in FIG. 6B)) to activate a function displaying a home page. Any progress made up to that point can be recorded and stored in the interactive learning system's server system.

FIG. 6B shows an example page 650 before a timer begins in the trace race activity. When the timer begins, a video file (“Video File #1” for convenience) begins to play while the stage curtain 651 spreads apart from the center to reveal the video. In an embodiment, the animation is effected by loading several images of the stage curtain in succession in which each image reveals more of the video. In an embodiment, the video serves the dual purpose of showing users how to write a letter and representing the elapse of time according to the timer. The video portrays a figure 611, such as a cartoon dog, writing the example letter (“a” in this case) at least one time on a chalkboard. In an embodiment, the number of times the figure 611 writes the letter is the same as the number of input boxes 613. The user must write the letter in each of the five text input boxes before the cartoon dog finishes writing the letter five times. That is, the user must write the letter in each of the five text input boxes before playback of Video File #1 ends.

FIG. 8 is a flowchart illustrating an example method 800 for providing a GUI via the trace race activity of FIGS. 6A and 6B. In an embodiment, the trace race can have two modes of operation: trace race, and blind trace race. Each round can correspond to a different mode of operation. In embodiments, a first round uses a trace race mode of operation, and a second round uses a blind trace race mode of operation.

The method 800 begins at step 801 by setting the round index. The round index can correspond to different modes of operation, as further discussed below. The round index is incremented at the end of the round (box 823) to track the round. The method 800 also uses a current index to track how many times the user has written a letter in the current round (such as which the input box 613 the user is current providing input in). In step 803, the method 800 displays the instructions corresponding to the current round, and resets the current index. The trace race begins in step 805 when a timer begins. The beginning of the timer can be represented by an animation. As described above, a curtain can part and reveal an animated character writing the letter. The speed of the playback of the Video File #1 can be predefined by the platform to correspond to how long the user has to complete the exercise. In an embodiment, the speed of the playback of the Video File #1 can be predefined by the user or other resource. In an embodiment, step 807 takes place simultaneously with step 805. In step 807, the input box in which user input is expected is cleared (if necessary). The method 800 then queries in step 809 whether this is the first round (for example, round index=1). If this is the first round, the input box at the current index displays the trace letter (box 811). This can provide some guidance for the user. If this is not the first round, no letter is displayed in the input box and the user writes the letter “blind” (box 813). In an embodiment, the user input is provided by drawing the correct letter on a touchscreen of a user terminal. In alternative embodiments, the user input is provided by a mouse or a stylus. In step 815, the method 800 determines via a handwriting recognition engine of the platform whether the user input letter has been written correctly. If the response is correct, the method proceeds to step 817 in which a sound file of the lesson's “target phoneme” plays, while simultaneously the picture of the “standard font image” is displayed in the box, the current index is incremented, and the picture of the “example letter” appears in the next box corresponding to the current index. The user must then draw the correct letter in this next box. In an embodiment, the display of the “example letter” is replaced with a standard font image of the same letter. In step 815, if the user input is incorrect, the method 800 returns to step 807, and the user can draw the letter again.

After each correct response, the method 800 queries whether the user has correctly drawn the “letter” a predefined number of times, for example in each of the five boxes (box 819). That is, the method 800 checks whether the current index is below a predefined number (“5” here). If the current index is below a predefined number, the method 800 determines whether the timer is running (i.e., there is still time remaining) in step 821. If the time is still running, the method increments the round index in step 823 and if it is determined that additional rounds remain in step 825. In an embodiment, the number of remaining rounds is tracked by the round index (as described above). The platform can predefine the number of rounds a user completes before the method 800 ends. If additional rounds do not remain, the method 800 ends. The end of a round can be signaled by an animation. For example, several images can be shown in succession in which the “stage curtain” closes to obscure the video. In another embodiment, a video file plays showing images of shooting stars accompanied by a sound file, such as “Great. You beat me in the Trace Race. Let's learn some new words.” In an embodiment, after the method 800 ends, the user can be advanced to the next section “Vocabulary” as further described below.

However, if a user did not complete drawing all the letters correctly within the time limit in step 821, the method 800 returns to step 807 in which previous inputs to the input boxes are erased. For example, a new video file corresponding to a new timer can begin playing replacing the old video file, before the old video file stops. In an embodiment, in subsequent attempts of the trace race, a different video file (“Video File #2” for convenience) corresponding to an error message plays. For example, Video File #2 can also clear the input box corresponding to step 807 by showing Professor Pup walk across the GUI and erase all the letters he drew on a blackboard while the user's input boxes are simultaneously cleared. In embodiments, if the round index indicates that it is a first round, at the end of Video File #2, curtains close to at least partially obscure the video, and the user returns to a Trace activity. If the round index indicates that it is not a first round, the user repeats the current round. In an embodiment, in subsequent attempts of the trace race, a different video file corresponding to a different time limit plays. In another embodiment, the same video file as round one plays. In another embodiment, at the conclusion of an attempt at completing the trace race beyond the first round, the user must repeat the “Trace” activity corresponding to method 700 above.

In an embodiment, if the timer expires in round 1, the user is sent back to the Trace activity. If the time expires in round 2, the user must repeat the round 2 activity. In an embodiment, the number of rounds allowed can be predetermined. In an embodiment, the number of tries that a user has to complete or attempt an activity can be predetermined. In an embodiment, if time expires and the number of tries and/or rounds allowed has been met and/or exceeded, then another action or event is activated. For example, the user is then instructed that the activity is over. Or, for example, the user is then sent to a different activity. Or, for example, the user is then given an audio and/or text and/or video notice. The notice can be, for example, a message that the user exceeded the number of tries and/or rounds, and/or that the user needs to go to a different activity, etc.

In the blind trace race mode of operation, the “example letter” is not displayed in the input boxes. In embodiments, other than not displaying an example letter, the trace race proceeds in the same way as the trace race mode above. That is, users can input the letter a predefined number of times. In embodiments in which instructions in step 803 are provided through audio, the sample can contain the instruction, “Wow, you're fast, but look out, this time it's harder. Write the sound in the first box to get to the next box. Can you do it from memory? You can try. Ready, set,” followed by a sound file of the lesson's “target phoneme.” Then Video File #1 starts and the curtain opens. The user must draw the correct letter on the tablet surface in the leftmost box, and the handwriting recognition engine determines if the letter has been written correctly. This can be repeated for a predefined number of input boxes on the GUI.

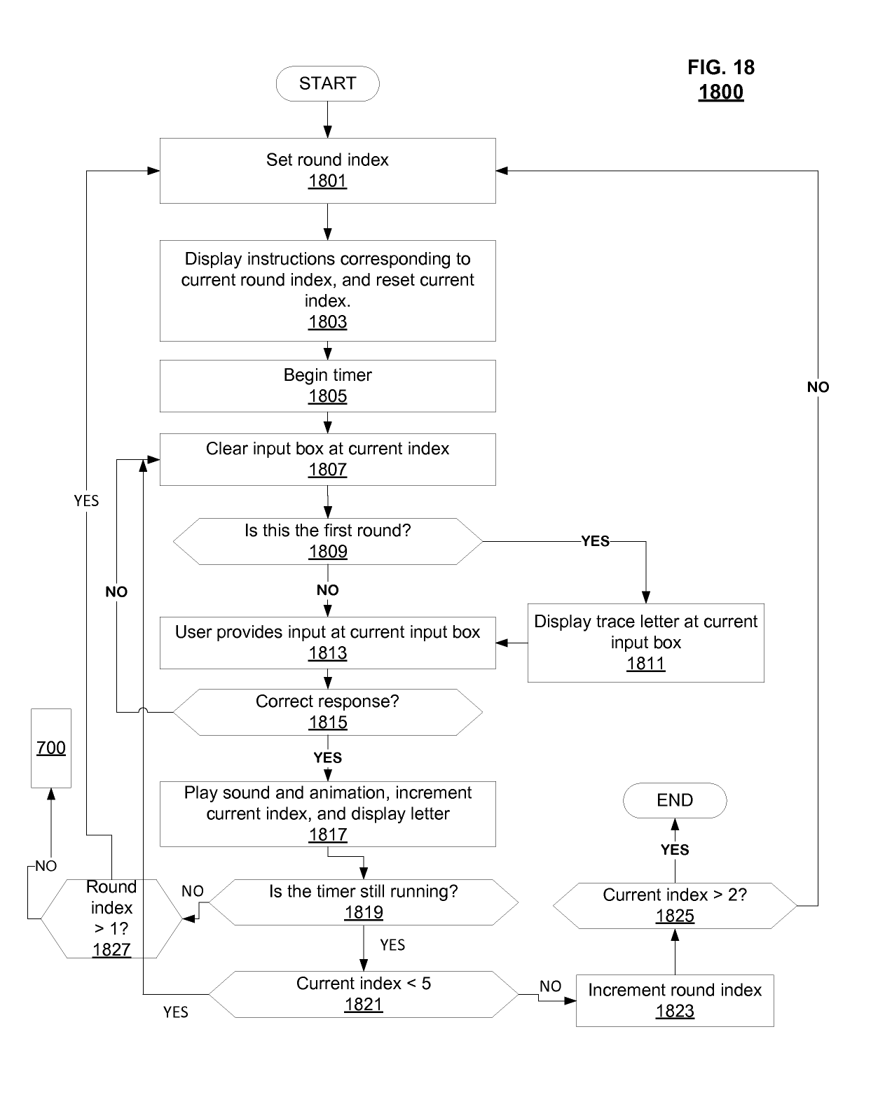

FIG. 18 is a flowchart illustrating an example method 1800 for providing a GUI via the trace race activity of FIGS. 6A and 6B. In an embodiment, the trace race can have two modes of operation: trace race, and blind trace race. Each round can correspond to a different mode of operation. In embodiments, a first round uses a trace race mode of operation, and a second round uses a blind trace race mode of operation.

The method 1800 begins at step 1801 by setting the round index. The round index can correspond to different modes of operation. The method 1800 can use a current index to track how many times the user has written a letter in the current round (e.g., the input box 613 the user is current providing input in). In step 1803, the method 1800 displays the instructions corresponding to the current round, and resets the current index. The trace race begins in step 1805 when a timer begins. The beginning of the timer can be represented by an animation. A curtain can part and reveal an animated character writing the letter. The speed of the playback of the Video File can be predefined by the platform to correspond to how long the user has to complete the exercise. In an embodiment, the speed of the playback of the Video File can be predefined by the user or other resource. In an embodiment, step 1807 takes place simultaneously with step 1805. In step 1807, the input box in which user input is expected is cleared (if necessary). The method 1800 then queries in step 1809 whether this is the first round (for example, round index=1). If this is the first round, the input box at the current index displays the trace letter (box 1811). This can provide some guidance for the user. If this is not the first round, no letter is displayed in the input box and the user writes the letter “blind” (box 1813). In an embodiment, the user input is provided by drawing the correct letter on a touchscreen of a user terminal. In alternative embodiments, the user input is provided by a mouse or a stylus. In step 1815, the method 1800 determines via a handwriting recognition engine of the platform whether the user input letter has been written correctly. If the response is correct, the method proceeds to step 1817 in which a sound file of the lesson's “target phoneme” plays, while simultaneously the picture of the “standard font image” is displayed in the box, the current index is incremented, and the picture of the “example letter” appears in the next box corresponding to the current index. The user must then draw the correct letter in this next box. In an embodiment, the display of the “example letter” is replaced with a standard font image of the same letter. In step 1815, if the user input is incorrect, the method 1800 returns to step 1807, and the user can draw the letter again.

After each correct response, the method 1800 plays sound and/or animation and/or text and/or other notification to indicate the user's success 1817. The current index is also incremented, and the letter is displayed 1817. The method 1800 then queries whether the timer is still running 1819. If yes, then, the method 1800 queries whether the user has correctly drawn the “letter” a predefined number of times, for example in each of the five boxes (box 1821). That is, the method 1800 checks whether the current index is lower than a predefined number (“5,” for example, here). In an embodiment, if the time is still running, the method 1800 increments the round index in step 1823 and determines whether additional rounds are still to do by the user in step 1825. If the current index is greater than 2 in step 1825, then the method ends. If the current index is not greater than 2, the the user begins with setting the round index 1801. In an embodiment, the number of remaining rounds is tracked by the round index. The platform can predefine the number of rounds a user completes before the method 1800 ends. If additional rounds do not remain, the method 1800 ends. The end of a round can be signaled by an animation. For example, several images can be shown in succession in which the “stage curtain” closes to obscure the video. In another embodiment, a video file plays showing images of shooting stars accompanied by a sound file, such as “Great. You beat me in the Trace Race. Let's learn some new words.” In an embodiment, after the method 1800 ends, the user can be advanced to the next section “Vocabulary” as further described below.

If the time 1819 is not still running, then the round index is checked by the method 1800 1827. If the round index is greater than 1, then the user begins with step 1801 again. If the round index is less than or equal to 1, then the user is directed to the method shown in FIG. 7. The user then completes steps 701 to 709.

If a user did not complete drawing all the letters correctly within the time limit 1819 and 1821, the method 1800 returns to step 1807 in which previous inputs to the input boxes are erased. For example, a new video file corresponding to a new timer can begin playing replacing the old video file, before the old video file stops. In an embodiment, in subsequent attempts of the trace race, a different video file (“Video File #2” for convenience) corresponding to an error message plays. For example, Video File #2 can also clear the input box corresponding to step 1807 by showing Professor Pup or other character/avatar walk across the GUI and erase all the letters he drew on a blackboard while the user's input boxes are simultaneously cleared. In embodiments, if the round index indicates that it is a first round, at the end of Video File #2, curtains close to at least partially obscure the video, and the user returns to a Trace activity. If the round index indicates that it is not a first round, the user repeats the current round. In an embodiment, in subsequent attempts of the trace race, a different video file corresponding to a different time limit plays. In another embodiment, the same video file as round one plays. In another embodiment, at the conclusion of an attempt at completing the trace race beyond the first round, the user must repeat the “Trace” activity corresponding to method 700 above.

In the blind trace race mode of operation, the “example letter” is not displayed in the input boxes. In embodiments, other than not displaying an example letter, the trace race proceeds in the same way as the trace race mode above. That is, users can input the letter a predefined number of times. In embodiments in which instructions in step 1803 are provided through audio, the sample can contain the instruction, “Wow, you're fast, but look out, this time it's harder. Write the sound in the first box to get to the next box. Can you do it from memory? You can try. Ready, set,” followed by a sound file of the lesson's “target phoneme.” Then Video File #1 starts and the curtain opens. The user must draw the correct letter on the tablet surface in the leftmost box, and the handwriting recognition engine determines if the letter has been written correctly. This can be repeated for a predefined number of input boxes on the GUI.

FIGS. 9A and 9B show example pages and for providing GUIs 910 and 950 for a vocabulary (also referred to as “Vocab”) activity. FIG. 9A shows an example page 910 after two letters have been written by a user via a user input section 915. FIG. 9B shows an example page 950 after a user completes a word via a user input section 915. This section enables the user to say out-loud each phoneme in a given word, to write each letter in a given word, and to read a given word out-loud. In an embodiment, each of the GUIs 910 and 950 is divided into two sections: a bottom section 915 contains several text input boxes 919a, 919b, and 919n. The number of text input boxes can correspond to the length of the word the current section is teaching (also referred to as “target word”). In an embodiment, each text input box corresponds to each letter of the target word. Images of the target word and other animations can be displayed in the top section 917. In an embodiment, the top section 917 contains an image of three pipes situated on three hills. In an embodiment, the bottom section is 1024 by 307 pixels and the top section 917 is 1024 by 471 pixels.

FIG. 10 is a flowchart illustrating a method 1000 for providing a GUI via the vocabulary activity of FIGS. 9A and 9B. In an embodiment, for each lesson's Vocab section, there can be a list of words the user must master. For example, this word list is predefined by the platform and can be stored in a .csv file on the platform. In a first step of the method 1000, the word list for the target phoneme is loaded. One word can be presented at a time. In an embodiment, each word of the word list corresponds to a word index, and each letter of each word corresponds to a letter index. In steps 1003 and 1005, the word index and the letter index are reset. In step 1007, the method 1000 prompts users to say the first phoneme of a given word out-loud. For example, the method 1000 can display instructions for user speech input of a letter of a word. The letter for which instructions are given can be tracked with the letter index. For example, if the word is “win” the user hears the phrase “Say /w/” wherein /w/ is the phonemic sound of the letter “w.” In step 1009, the user provides a speech input, and stand by for a response from the user. In an embodiment, if the platform detects that a predefined volume threshold has been reached, a sound file “ding” plays, and plays an animation. For example, an image of a cloud emerges and then disappears on the GUI to give the user a visual cue that the speech input was registered. In an embodiment, a system is used which recognizes that a speech input has been provided. In an embodiment, speech recognition software program/system is used to determine the accuracy of the user's speech input. The method 1000 then proceeds to step 1011 in which the user is prompted to write a letter corresponding to the letter index of a the target word. For example, if the word is “win,” the user hears the phrase “Write /w/” and the user is then prompted to draw the letter “w” in the first text input box. In step 1013, the user provides a written input. If the handwriting recognition engine determines that the letter has been drawn correctly in step 1015, the platform can respond in the same manner as that described above when a sound is registered. In an embodiment, if the response is unknown, after a predetermined time elapses, the method 1000 proceeds to step 1025. In an embodiment, the GUI further simultaneously replaces the users drawn input with a standard font image of the same letter.

If the handwriting recognition engine determines that the letter has been written incorrectly in step 1015, a series of the anthropomorphic letters can appear in a phoneme bar (further discussed below), and the user can receive help in step 1025. For example, a sound file can play, stating, “Touch the letters to hear the sounds.” If the user touches any of these letters, a sound file plays. This can be by means of a method 1500 further discussed below. This sound file is the phonemic sound with which the letter corresponds. For example, if the letter is “w” the sound file is the phonemic sound /w/. By touching these letters, the user can determine which sound the program is asking him to write. The method then returns to step 1013. Once the user writes the correct letter in step 1013, the above process repeats for the next letter in the word by incrementing the letter index in step 1017, and hiding the phoneme help bar, if applicable. For example, if the word is “win” the software says “Say /i/.” This process can continue until the user has said out-loud every phoneme, and written every single letter in the word. Whether all letters for the target word have been completed is determined in step 1019 in which the letter index is compared with the word length. In embodiments, the letter index of the last letter in a target word is equivalent to the length of the word in number of letters. In embodiments, the reading of the entire word out-loud is optional. In embodiments, once a word is complete, instructions for reading the entire word corresponding to the current word index is displayed in step 1021. For example, once the user has correctly written each letter in the word, the text image boxes merge to become one contiguous box and the font images of the letters slide together to form a word with normal kerning. After the letters have slid together, the user hears a sound file alerting the user to do an action. For example, the sound files states “Tap the microphone, and then read this word out-loud.” The user then taps an icon of a microphone, which enables and/or activates the speech recognition engine.

In an embodiment, if the user provides the correct response in step 1023, the image for the word is displayed and the user moves onto the next word in step 1029. In embodiments, the image displayed can be animated. For example, to correspond to a verb, Professor Pup “kicks” a ball. This can be done by incrementing the word index in step 1029. For example, if the speech recognition engine determines that the user has read the word correctly, a cloud emerges from a pipe in the center of the screen. If the word can be represented graphically by an image, an image depicting this word appears in the cloud. For example, if the word is “man” a picture of a “man” appears in the cloud. If the word is a concept such as an action (verb) or an adjective, or a preposition the cloud expands to a full size (for example, 1024 by 461 pixels) and a video can play depicting the sentiment of the word. For example, if the word is “kick” a video plays showing a cartoon character “kicking” an object such as a ball.

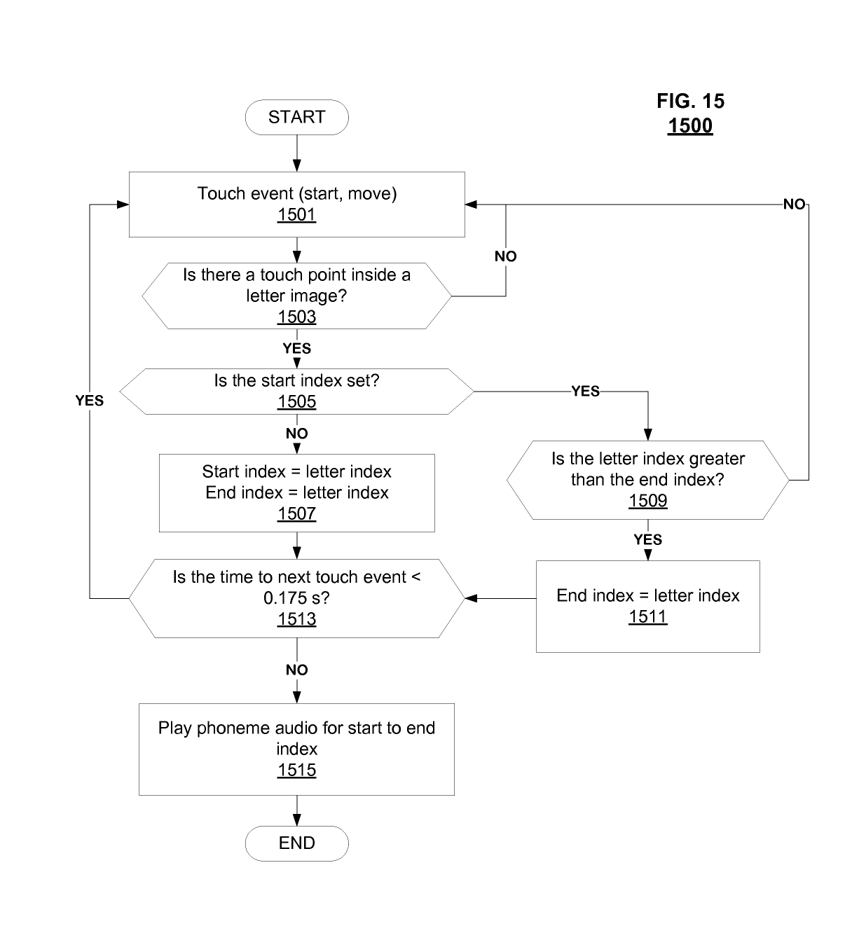

If an incorrect response is provided in step 1023, a TTS Box is displayed for the word at the current word index in step 1031. For example, if the speech recognition engine determines that the user has read the word incorrectly, a box (“TTS Box,” further discussed in relation to FIG. 15 below) appears in the center of the screen with that word spelled out with “anthropomorphic” letters. The user can touch each of the letters to trigger a sound file of the phoneme that that letter represents. The user can also swipe through the letters to hear a separate sound file that contains the sound of the phonemes blended together. These “anthropomorphic” letters assist the user to determine how to pronounce the word. Once the user touches the microphone icon, engaging the speech recognition, and correctly pronounces the word, the method 1000 can return to step 1005 (shown as a dashed line) and instructions for the next word can be presented.

The method 1000 repeats so long as words remain in the word list. That is, until all the words in that lesson's list have been correctly written and pronounced. Whether words remain on the word list is determined in step 1027 by checking whether a word index is less than the total word list length. If all words have been completed, the method 1000 ends. Otherwise, the method 1000 returns to step 1005 by resetting the letter index to correspond to the first letter of the next word. In an embodiment, after the method 1000 ends, the user can then be advanced to the section, “Story,” as further discussed below.

In an alternative embodiment, after a correct answer in step 1015, instead of an illustration of the word appearing in a cloud, the following animations can be displayed: the illustration appears on a “page” of an illustration of a “book”, or the illustration appears on a “page” of an illustration of a “book,” or in the upper portion of the screen, instead of three pipes on three hills, the upper portion of the screen contains an illustration of a laboratory with a pipe in the center, and an illustration of the word appears in a cloud emerging from the pipe.

In an alternative embodiment, after an incorrect answer in step 1015, the following animations can be displayed: a box appears in which a video shows the proper way to draw the letter, or a list of letters. If a list of letters is displayed, the user can touch each of these letters to play a sound file. This sound file is the phonemic sound associated with that letter. When the user touches the correct letter, a box can appear in which a video shows the proper way to draw the letter.

In an alternative embodiment, an arrow icon can further be displayed on the screen. Touching the arrow icon causes the program to register a correct answer in lieu of the speech recognition engine in step 1023 and advances the user to step 1029.

FIG. 11 shows an example page 1100 for providing a GUI for a review activity. In an embodiment, the “Review” section assesses the user's ability to spell words. There can be a list of words stored in a file on the platform. In an embodiment, the word list is a csv file. The user can be prompted to draw each of these words in a text input box 1115, one after the other. In an embodiment, the screen is divided into two parts, a top section 1117 and a bottom section 1100. The top section 1117 can provide a visual cue of a timer. In an embodiment, the top section 1117 is 1024 by 461 pixels, and contains an image of a “clock” with a cartoon character on the face of the clock. The cartoon character's arms point from the center of the clock towards the edge of the clock. As time elapses, the cartoon character's arms rotate around the clock clockwise to denote the passage of time similar to the minute and second hands of an ordinary clock. This can be accomplished through a series of images in which each successive image depicts the arms rotated incrementally further clockwise along one complete rotation around the edge of the clock. The period of time that elapses between the loading of each successive image is constant for a given lesson. However, the length of this period of time is variable across lessons and depends on the number of words the user is prompted to spell. The greater the number of words, the longer the period of time between successive files. For example, the time ratio can be 12 seconds per word on the associated word list.

The bottom section 1100 of the GUI contains a text input box 1115. In an embodiment, the bottom section 1115 has the dimensions 1024 by 307 pixels. When prompted, the user can draw a word in this box. A handwriting recognition engine can determine whether the user's input is correct. In an embodiment, to the right hand side of the clock, in the top section 1117 of the GUI, a button can be displayed, which if pressed will activate a function to delete the most recent entry in the text input box 1115. To the left hand side of the clock in the top part of the screen there a button can be displayed, which if pressed will activate a function to restart the level from the beginning.

FIG. 12 is a flowchart illustrating an example method 1200 for providing a GUI via the review activity of FIG. 11. In a first step 1201, the method 1200 loads a word list for a target phoneme. In step 1203, the method 1200 resets a word index and a timer 1203. The word index tracks, which word in the word list for which a user is providing responses.

In step 1205, the method 1200 displays instructions intended to elicit written input from the user. In an embodiment, an audio file (for convenience, “Review Audio File #1”) can play containing the instruction “Write”. This can be followed by an audio file, which is a recording of the first word in the list of words, which the user is prompted to spell. For example, the user might hear “Write Dad.” The user will then (ideally) draw the word “Dad” in the text input box. As soon as Review Audio File #1 and the audio file of the first word in the list finishes playing, the timer begins. For example, the “hands” of the “clock” start revolving. That is, the images depicting the clock start loading in sequence. In step 1207, the user provides a written input and the handwriting recognition engine can be activated. The method 1200 queries in step 1209 whether the user input is a correct response.

If the response is correct, the method 1200 then proceeds to step 1211 in which a sounds and animation is played, the word index is incremented, and the timer is paused. In an embodiment, if the user draws the correct word in the text input box, another audio file (Review Audio File #2 “ding” for convenience) plays and the clock image sequence stops on the most recent image. The method 1200 then proceeds to step 1205 in which the Review Audio File #1 plays followed by the audio file of next word in the list of words the user can spell. Then the timer can resume. In an embodiment, a clock image sequence resumes. (The clock begins “ticking” again.)

If the response is incorrect, the method 1200 can display more detailed instructions in step 1222. In an embodiment, if the user does not draw the correct word in the text input box, the audio file associated with this word plays again, followed by several audio files which correspond to each phoneme in that word. For example, if the word is “Dad” the user will hear, “Dad, /d/, /a/, /d/” (the letters within the backslashes indicate the phonemic sound that that letter represents). The method 1200 then returns to step 1207, in which the user can draw the word in the text input box.

Steps 1205 to 1211 can be repeated for all words in the word list. Completion of the word list can be determined in step 1213 by comparing the current word index to the length of the word list. If words remain, the method 1200 returns to step 1205. If all words have been completed, the method 1200 continues to step 1215. In an embodiment, after the user has correctly written each word from the list in the text input box, an audio file (“Review Audio File #3” for convenience) plays. In an embodiment, the audio file contains the instruction, “Congratulations, you've made it to level” followed by an audio file of a number that corresponds to the number of the current level plus one. For example, at the end of level one, the user would hear, “Congratulations, you've made it to level two.” In an embodiment, the user can then be advanced to the next section “Disco” in which a cartoon plays of several cartoon animals disco dancing to a pop song.

However, if the method 1200 determines in step 1217 that the time has run out before all words were completed, then the method 1200 can end in a different fashion. In an embodiment, if the user is not able to write all of the words in the word list before the last image in the sequence of the clock image loads (for example, the “hand” of the clock completes one full revolution), an audio file (“Review Audio File #4” for convenience) plays containing the instruction, “Not quite.” In an embodiment, the user can start the section again, e.g. the section repeats from step 1201. In an alternative embodiment, if the time completes before word index equals word list count, the method 1200 proceeds to step 1219 in which an incomplete sound and animation can be played before the method 1200 ends. If the timer does not complete before word index equals word list count, then the method 1200 proceeds to step 1215 in which a reward sound and animation can be played before the method 1200 ends.

At any point during the lesson, a user can reset the lesson in step 1228, which clears the reset word index and reset timer (box 1203). A user can also clear the current input in step 1224 by activating a link on the GUI. The method 1200 then clears the input box in step 1226.

In alternative embodiments, the timer can be represented by other images. For example, instead of a clock, a sequence of images depicting an “hourglass” with “sand” falling from the upper part of the hourglass to the lower part of the hourglass can be displayed. If the user is not able to write all of the words from the word list before the top part of the hourglass becomes empty, Review Audio File #4 plays containing the instruction “Not quite” and the method 1200 returns to step 1201.

A story activity can enable a user to read aloud each sentence in a story, one at a time. A list of these sentences can be stored in a file on the platform, for example a csv file. In a GUI corresponding to this story activity, a video file (“Story Video file #1” for convenience) can be displayed on a top section of the screen. In an embodiment, the top section is 1024 pixels by 461 pixels. In embodiments, there can be an icon of a microphone in the lower left corner of this section of the screen. There can be a box at the bottom of the screen in which the sentence can be displayed. In an embodiment, the bottom section can have dimensions 1024 pixels by 307 pixels. In an alternative embodiment, the box containing the sentence is on the top of the screen and the video file is on the bottom. In an alternative embodiment, the microphone icon is on the right-hand side of the screen. In an alternative embodiment, there is no microphone icon. After a sentence appears on the screen, the speech recognition turns on automatically.

FIG. 13 is a flowchart illustrating an example method 1300 for providing a GUI via a reading activity. In a first step 1301, a sentence index is reset. A story can be comprised of one or more sentences. The sentences can each correspond to a different sentence index. The sentence index can track which sentence a user is currently working with. The method 1300 then proceeds to step to 1303 in which instructions are displayed. In an embodiment, a sound file (“Story sound file #1” for convenience) can play containing the instruction, “Tap the microphone and read this sentence out-loud.” A sentence can be displayed in the bottom section of the screen in step 1305. The user can provide a response in step 1307. In an embodiment, the user touches a microphone icon on the GUI. This can engage the speech recognition engine. The user then reads the sentence out-loud. In step 1309, the method 1300 determines whether the user input provided in step 1307 is correct.

If the response is correct, the method 1300 can refresh the display, play an animation (“Story Video File” for convenience) corresponding to the sentence index, read the sentence to the user, and increment the sentence index. In an embodiment, if the user reads the sentence correctly, the sentence disappears and a Story Video File corresponding to the current sentence plays. In embodiments, there is separate story video file for each sentence. For example, in the first instance of step 1323, this file is Story Video File #2. In a second instance of step 1323, this file is Story Video File #3, etc. In an embodiment, the video file can contain a cartoon that depicts the action in the sentence the user has just read. There can be an audio component to the video file containing a “voice-over” which repeats the sentence the user has just read. Once the Story Video File finishes, if it determined that the story is incomplete in step 1325, a new sentence can appear in the box at the bottom section of the screen (box 1305). This sentence can be the next sentence in the story and can be drawn from the sentence index. Then the method 1300 continues with step 1307. Each new sentence can have a new Story Video File associated with it.

If the response is incorrect in step 1309, in step 1333, the word index is reset and instructions are displayed. Then the method proceeds to step 1329 in which every word in the sentence except the first word disappears from the bottom box. In an embodiment, a sound file (“Story Sound File #2” for convenience) plays containing the instruction, “Tap the microphone and read this word out loud.” If the user then provides a correct response in step 1311, the word disappears, the word index increments in step 1315. If words remain in the sentence in step 1317, the word at the current word index is displayed in step 1329. In an embodiment, the user can again touch the microphone icon and read the new word out-loud in step 1327. Steps 1329, 1327, 1311, 1313, and 1315 can be repeated as many times as necessary until the words of an entire sentence are individually read. As described above, the current word the user is working with can be tracked by means of a word index. In an embodiment, once every word has been read correctly, the entire sentence appears again, and the process begins anew from step 1305. In an alternative embodiment, the method 1300 continues to step 1323, in which the user is prompted to read the sentence again, and the method 1300 proceeds to the next sentence, if applicable. That is, if sentences remain in the story, as determined in step 1325.

However, if the user reads the word incorrectly in step 1311, a box appears (“TTS Box” further described below in relation to FIG. 15) in the center of the GUI containing the word spelled out with “anthropomorphic” letters. In an embodiment, the user can touch each of the letters to trigger a sound file of the phoneme, which that letter represents. The user can also swipe through the letters to hear a separate sound file that contains the sound of the phonemes blended together. These “anthropomorphic” letters assist the user to determine how to pronounce the word. The method then returns to step 1327, in which the user enables speech recognition (for example, the user touches the microphone icon), and correctly pronounces the word, the method continues from step 1315, and the next word is presented.

The method 1300 determined whether all the sentences in the Story section have been read correctly in step 1325. If all sentences have been read, the method 1300 ends. In an embodiment, the user can be advanced to the section “Review.” In an alternative embodiment, a link (for example, an arrow icon) is displayed on the screen. Activating the link (for example, touching the arrow icon) can cause the program to register a correct answer in step 1309 and advance the user to the next sentence.

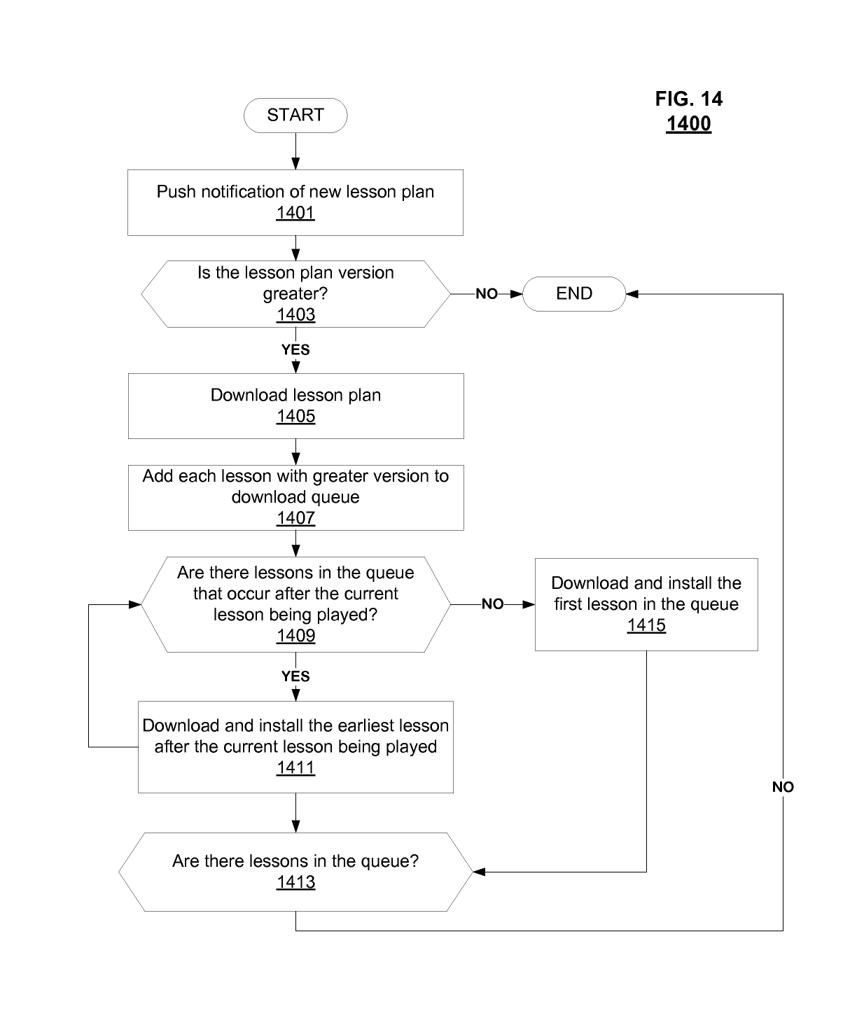

FIG. 14 is a flowchart illustrating an example method 1400 for updating content based on lesson progress. In an embodiment, all lessons use the same templates for activities as described above. Each lesson teaches a different phoneme, and therefore new content is loaded in the same templates. In a first step 1401, the method 1400 begins determining whether lesson plan content is to be updated by pushing notification of a new lesson plan. If the lesson plan version that is currently loaded is greater than the notification in step 1403, the method 1400 ends and no update is made, because the content is up-to-date. In an embodiment, a lesson plan version is considered greater than another lesson plan version, if the concepts (phoneme) being taught is later in a sequence such as the sequence described above. If the method 1400 determines that the currently-loaded lesson is of a lesser version than the notification, the lesson plan corresponding to the notification is downloaded in step 1405. The method 1400 can then download lessons with versions greater than the present lesson in a download queue in step 1407. The method 1400 then examines the download queue and determines whether there are any lessons that occur after the one being played in step 1409. That is, whether there are any lessons with greater versions. In an embodiment, a lesson plan version is considered greater than the current lesson plan if it contains newer assets. If no such lessons exist (that is, there is only a single lesson on the queue), the method 1400 downloads and installs the first lesson in the queue in step 1415, and proceeds to step 1413. If such lessons exist, the method 1400 downloads and installs the earliest lesson after the current lesson being played in step 1411. In an embodiment, the first lesson in the queue corresponds to the lesson that is to be taught immediately subsequent to the present lesson based on a sequence described above. After the lesson is completed, the method 1400 then queries in step 1413 whether there are any lessons in the queue in step 1413. If not, the method 1400 ends.

FIG. 15 is a flowchart illustrating an example method 1500 for transferring touch gestures, including swiping, to speech (also referred to as “TTS” swiping). The touch gestures refer to interaction with a touch screen at a user terminal. In an embodiment, swiping is passing an appendage across one or more letters a touch-sensitive screen. In another embodiment, swiping is mousing over one or more letters displayed on a GUI. In an embodiment, the letters can appear in a phoneme bar described herein. For example, a word “golf” can be displayed on a GUI that user can swipe across. The word can contain one or more phonemes that the user can hear by swiping across the letters. The word “golf” is indexed, with the letter “g” corresponding to an index of 1, “o” corresponding to an index of 2, and so on. When the user swipes over three of the letters, “gol,” the swiping range is 1-3, and the platform will play the phoneme(s) corresponding to those letters. If he swipes over “olf,” the swiping range is 2-4, and the platform will play the phoneme(s) corresponding to those letters.

As described above, each letter can correspond to a start and end index. A letter corresponds to a letter index. In a first step 1501, a touch event occurs. For example, a touch event can be characterized by a starting point (also “touch point”) and a motion. The method 1500 queries in step 1503 whether the touch point falls inside a letter image. In an embodiment, the letter image corresponds to an “anthropomorphic letter.” A touch point can fall inside a letter image as determined by a point falling inside a perimeter of the letter or within a region near a letter. If the touch point falls inside a letter image, the method 1500 determines whether a start index is set in step 1505. However, if the touch point does not fall inside a letter image, the method 1500 stands by for another touch event in step 1501. If the method 1500 determines that the start index is not set in step 1505, it sets the start index to be the letter index, and the end index to the letter index. The method 1500 then stands by for the next touch event in step 1513. However, if the method 1500 determines that the start index is set in step 1505, it queries whether the letter index is greater than the end index in step 1509. The method 1400 then sets the end index to the letter index. The method 1400 then proceeds to step 1513. In step 1513, the method 1400 determines whether the next touch event takes place within a predefined time period. In an embodiment, the time periods 0.175 seconds (as shown). If the time to the next touch event is less than the predefined time period, the method 1400 stands by for the next touch event in step 1501. If the time to the next touch event is greater than equal to the predefined time period in step 1513, the method 1500 recognizes the one or more letters indicated by the touch gesture, and can play the phoneme audio corresponding to the start to end index in step 1515.

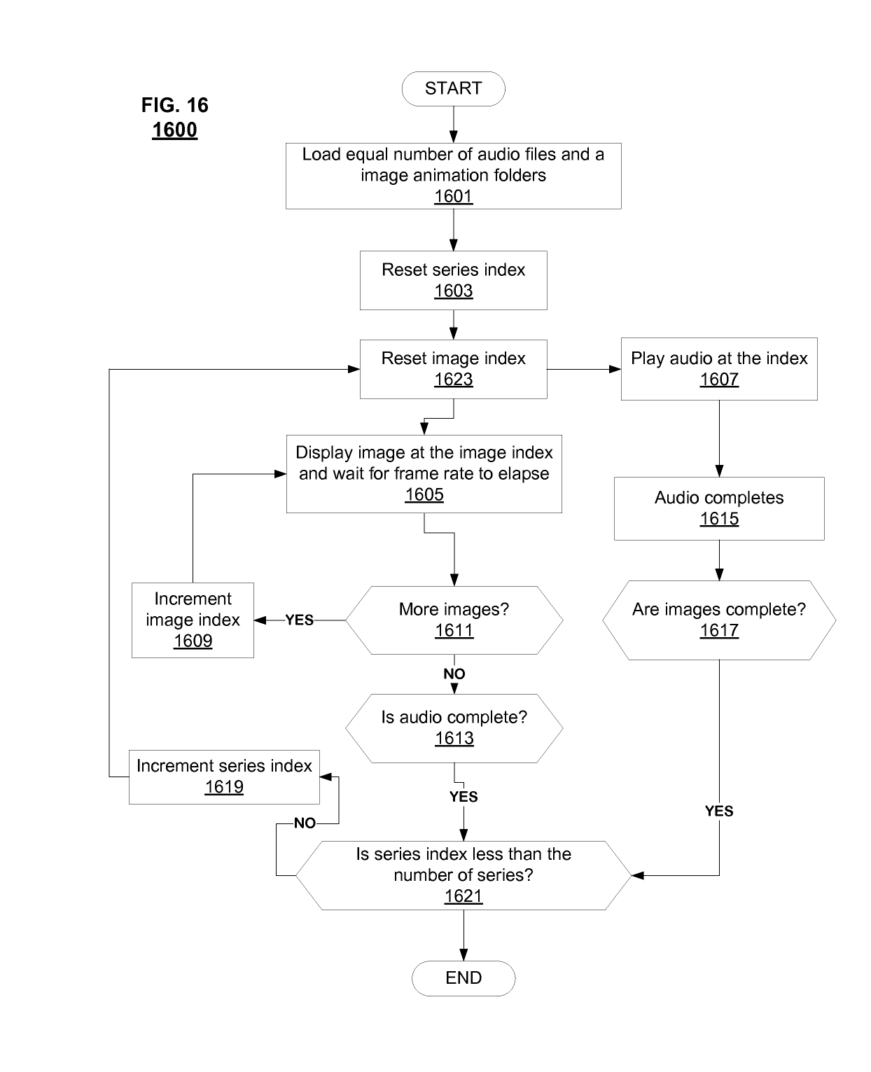

FIG. 16 is a flowchart illustrating an example method 1600 for synchronizing a series of audio and image-based animation. Each part of a series corresponds to a series index. In a first step 1601, the method 1600 loads an equal number of audio and image animation files. The method 1600 then resets a series index in step 1603 and resets an image index in step 1623. Upon loading a GUI (as described above), the method 1600 simultaneously displays an image at the image index and waits for a frame rate to elapse (box 1605), and plays audio at the series index (box 1607). The audio completes in step 1615, and if the images are also complete 1617, then the method 1600 queries whether the series is complete in step 1621. In an embodiment, the series is incomplete if the series index is less than the number of parts in the series. If the series is complete, the method 1600 ends. Otherwise, the series index is incremented and the method 1600 returns to step 1623. On the image side, the method 1600 queries in step 1611 whether more images are to be loaded. In an embodiment, the determination is made by a comparison of the image index to the total number of images. If more images are to be loaded, the image index is incremented in step 1609, and the method 1600 continues to step 1605 to display the next image. However, if all images have been displayed, then the method 1600 determines whether the audio has finished already as well in step 1613.

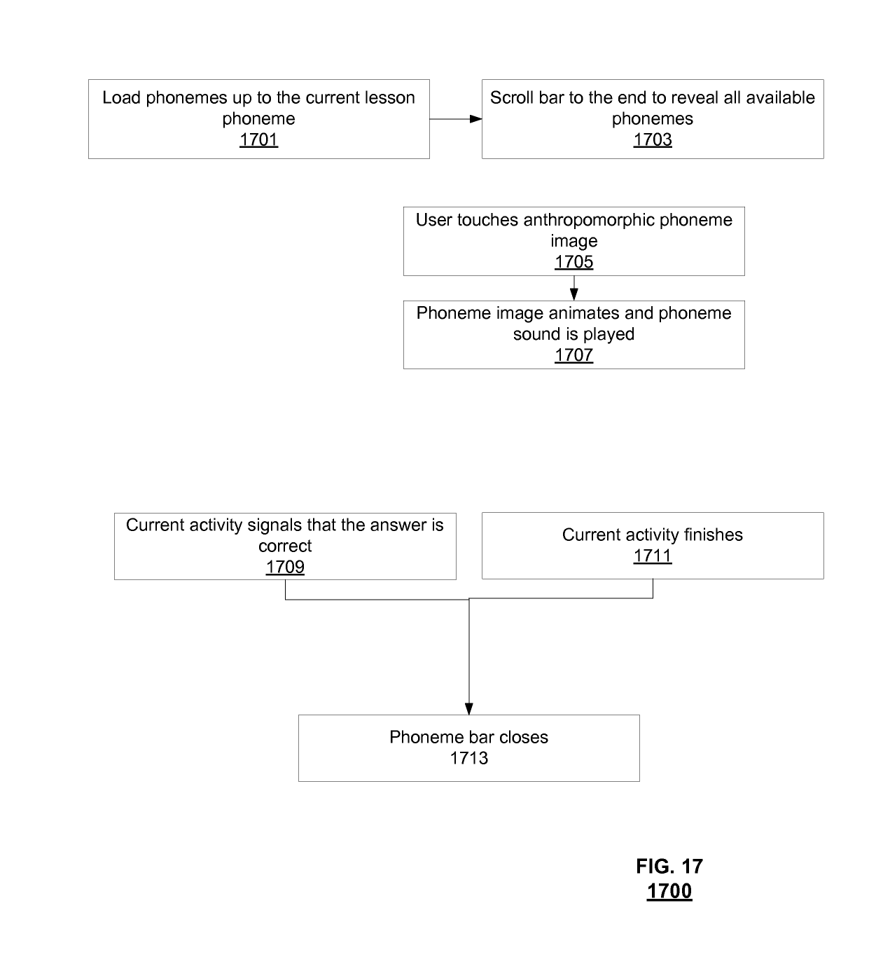

FIG. 17 is a flowchart illustrating an example method 1700 for displaying a phoneme bar in a GUI. The phoneme bar can provide help when a user is stuck. In embodiments, the phoneme bar is available in any activity, for example when a user provides an incorrect response. In step 1701, the method 1700 loads the phonemes learned in pervious lesions and the current target phoneme. If not all the phonemes are visible on the GUI, the method 1700 can provide a scroll bar to reveal all available phonemes. In an embodiment, the scroll bar is horizontal. In another embodiment, the scroll bar is vertical. In step 1705, the user can select an anthropomorphic phoneme image, for example by touching an area corresponding to the image on a touch screen of a user terminal. The phoneme image is then animated and a corresponding sound representing the phoneme is played in step 1707. The phoneme bar can close (box 1713) upon a signal by the current activity that an answer provided by the user is correct (1709) or if the activity is complete (box 1711).

The descriptions and illustrations of the embodiments above should be read as exemplary and not limiting. For instance, versions of the interactive learning system teaching more advanced concepts are possible. The content of sound files provided are exemplary, and it is possible to convey similar information using different words of information, encouragement, and correction. The present invention includes variations from the specific examples and embodiments described herein. Except to the extent necessary or inherent in the processes themselves, no particular order to steps or stages of methods or processes described in this disclosure, including the figures is implied. In many cases, the order of process steps may be varied without changing the purpose, effect or import of the methods described. Modifications, variations, and improvements are possible in light of the teachings above and the claims below, and are intended to be within the spirit and scope of the invention.

The various computer and/or processor systems described herein may each include a storage component for storing machine-readable instructions for performing the various processes as described and illustrated. The storage component may be any type of machine readable medium such as hard drive memory, flash memory, floppy disk memory, optically-encoded memory (e.g., a compact disk, DVD-ROM, DVD±R, CD-ROM, CD±R, holographic disk, non-transitory medium), a thermomechanical memory (e.g., scanning-probe-based data-storage), or any type of machine readable storing medium. Each processor system may also include addressable memory (e.g., random access memory, cache memory) to store data and/or sets of instructions that may be included within, or be generated by, the machine-readable instructions when they are executed by a processor on the respective platform. The methods and systems described herein may also be implemented as non-transitory machine-readable instructions stored on or embodied in any of the above-described or other storage mechanisms.

What is claimed is:

1. A method for electronically teaching phonics comprising:
presenting phonemes, using a computer processor, in the following order: “p,” “u,” “o,” “t,” “n,” “a,” “d,” “i,” “g,” “b,” “m,” “e,” and “h.”

2. The method according to claim 1, further comprising:
presenting at least the following words, using the computer processor, following the presentation of the phonemes “p” and “u”: up, pup;
presenting at least the following word, using the computer processor, following the presentation of the phonemes “p,” “u,” and “o”: pop;
presenting at least the following words, using the computer processor, following the presentation of the phonemes “p,” “u,” “o,” and “t”: pot, top;
presenting at least the following words, using the computer processor, following the presentation of the phonemes “p,” “u,” “o,” “t,” and “n”: nut, on, not;
presenting at least the following words, using the computer processor, following the presentation of the phonemes “p,” “u,” “o,” “t,” “n,” and “a”: ant, nap, tap, pat;
presenting at least the following words, using the computer processor, following the presentation of the phonemes “p,” “u,” “o,” “t,” “n,” “a,” and “d”: dad, dot, pad, pond;
presenting at least the following words, using the computer processor, following the presentation of the phonemes “p,” “u,” “o,” “t,” “n,” “a,” “d,” and “i”: pit, pin, nip, dip, tip;
presenting at least the following words, using the computer processor, following the presentation of the phonemes “p,” “u,” “o,” “t,” “n,” “a,” “d,” “i,” and “g”: dog, tag, pig, dug, dig, tug;
presenting at least the following words, using the computer processor, following the presentation of the phonemes “p,” “u,” “o,” “t,” “n,” “a,” “d,” “i,” “g,” and “b”: bug, bat, bag, tub, big, bad, bit;
presenting at least the following words, using the computer processor, following the presentation of the phonemes “p,” “u,” “o,” “t,” “n,” “a,” “d,” “i,” “g,” “b,” and “m”:
mop, mat, man, map, mad, mud, gum, damp;
presenting at least the following words, using the computer processor, following the presentation of the phonemes “p,” “u,” “o,” “t,” “n,” “a,” “d,” “i,” “g,” “b,” “m,” and “e”: bed, ten, men, pen, net, pet, met, tent, mend, bend; and
presenting at least the following words, using the computer processor, following the presentation of the phonemes “p,” “u,” “o,” “t,” “n,” “a,” “d,” “i,” “g,” “b,” “m,” “e,” and “h”: ham, hog, hen, hip, hut, hat, hit, hop, hid, hot, hug, hunt, hand, bop.

3. A method for electronically teaching a phoneme, the method comprising:
playing, using a computer processor, a sound of a phoneme;
displaying, using the computer processor, a letter that represents the phoneme after playing the sound;
displaying at least one word which contains the phoneme;
displaying, using the computer processor, a GUI for selection of a correct picture whose name corresponds to the phoneme;
displaying, using the computer processor, a letter that represents the phoneme, after displaying the GUI; and
displaying, using the computer processor, a way of writing the letter without referring to the name of the letter.

4. The method according to claim 3, further comprising playing, using the computer processor, a song using the phoneme.

5. A method for electronically teaching a phoneme, the method comprising:
loading, using a computer processor, a word pair list for the phoneme;
resetting, using the computer processor, a pair index;
displaying images associated with the word pair for a current pair index;
enabling a speech recognition engine to determine a user input;
playing, using the computer processor, at least one of: a sound and a animation corresponding to the user input provided, wherein the user input is one of: unknown, incorrect, and correct;
responsive to the user input being at least one of: correct and incorrect, incrementing the pair index using the computer processor; and
responsive to a determination that the pair index is less than the total number of word pairs, returning to displaying images associated with the word pair for a current pair index.

6. The method according to claim 5, further comprising responsive to a determination that the current pair index is less than a predefined number, playing, using the computer processor, a sound corresponding to the images.

7. A method for electronically teaching a phoneme, the method comprising:
displaying, using a computer processor, instructions for writing a letter corresponding to the phoneme;
receiving a user input;
determining, using the computer processor, that the user input corresponds to the letter;
responsive to a determination that the user input corresponds to the letter, at least one of: displaying at least one of: an image and an animation, of the letter, playing an animation, and playing a sound.

8. The method according to claim 7, wherein the image is anthropomorphic, having at least one eye.

9. The method according to claim 7, further comprising adding the letter to a phoneme bar responsive to a determination that the user input corresponds to the letter.

10. A method for electronically teaching a phoneme, the method comprising:
displaying, using a computer processor, instructions corresponding to a round index and resetting a current index;
beginning a timer;
clearing an input box at the current index;
responsive to a determination by the computer processor that the user input is correct, incrementing the current index and at least one of: displaying an image of the letter, playing an animation, and playing a sound;
responsive to a determination that the current index is more than a second predetermined number, determining whether the timer is still running;
responsive to a determination that the timer is still running, incrementing the round index.

11. The method according to claim 10, wherein the letter is anthropomorphic, having at least one eye.

12. The method according to claim 10, further comprising responsive to a determination that the round index is equal to a first predetermined number, displaying, using the computer processor, a trace letter at the input box and receiving a user input.

13. A method for electronically teaching a phoneme, the method comprising:
loading, using a computer processor, a word list for the phoneme;
resetting, using the computer processor, a word index and a letter index;
receiving a first user speech input and a user written input;
responsive to a determination by the computer processor that at least the user written input is correct, incrementing the letter index;
responsive to a determination that the letter index is greater than the word index, receiving a second user speech input; and
responsive to a determination by the computer processor that the second user speech input is correct, displaying at least of: an image and an animation, for the word and incrementing the word index.

14. The method according to claim 13, wherein the letter index is incremented responsive to a determination both the user speech input and the user written input are correct.

15. A method for electronically teaching a phoneme, the method comprising:
loading, using a computer processor, a word list for the phoneme;
resetting, using the computer processor, a word index and a timer;
receiving a user input;
responsive to a determination by the computer processor that the user input is correct, pausing the timer, incrementing the word index, and displaying at least one of:
a sound and animation; and
responsive to a determination by the computer processor that the timer completes before the word index reaches the number of word pairs in the word list, returning to loading a word list for the phoneme.

16. A method for electronically teaching reading, the method comprising:
displaying, using a computer processor, a sentence corresponding to a sentence index;
receiving a first user input corresponding to reading the sentence;
responsive to a determination by the computer processor that the first user input is correct, at least one of: clearing the sentence from the display, playing an animation, reading the sentence to the user, and incrementing the sentence index;
responsive to a determination by the computer processor that the first user input is incorrect, displaying a first word of the sentence;
receiving a second user input for the first word of the sentence; and
responsive to a determination by the computer processor that the second user input is incorrect, enabling touch to speech for the first word.

17. A method for outputting a sound responsive to receiving a touch input, the method comprising:
receiving, via a touch-sensitive user terminal, a touch event having a touch point;
responsive to a determination by a computer processor that the touch point is at least one of: inside a perimeter of a letter image and near the perimeter of the letter image, determining whether a start index is set;
responsive to a determination by the computer processor that the start index is not set, setting a start index equal to a letter index and an end index equal to the letter index;
responsive to a determination by the computer processor that the start index is set, determining whether the letter index is greater than the end index;
responsive to a determination by the computer processor that the end index equals the letter index, waiting for a next touch event; and
responsive to a determination by the computer processor that the next touch event occurs in greater than or equal to a predetermined time period, playing a sounds corresponding to a start to end index.

18. The method according to claim 17, wherein the letter image is at least one of:
anthropomorphic and animated, anthropomorphic including having at least one eye.
